(19) United States
(12) Patent Application Publication
(10) Pub. No.: US 2008/0281914 A1
(43) Pub. Date: Nov. 13, 2008

(54) Computer system

(75) Inventor: Tatsuhiko Miyata, Inagi (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/071,901

(22) Filed: Feb. 27, 2008

(30) Foreign Application Priority Data
May 10, 2007 (JP) 2007-125376

(51) Int. Cl. G06F 15/16

(52) U.S. Cl. 709/204

(57) ABSTRACT

There is provided a computer system comprising a plurality of first computers operated by users and a second computer coupled to the plurality of first computers via a network. The second computer receives a group creation request from one of the plurality of first computers; creates a group to which one or more of the users belong based on the received group creation request; specifies, among users having relation to a user who operates the one of the plurality of first computers that transmitted the received group creation request, users not belonging to the created group as leakage destination users; and transmits information received from one of the plurality of first computers operated by one of the users belonging to the created group to first computers operated by the specified leakage destination users.

### CLAIM OF PRIORITY

The present application claims priority from Japanese patent application P2007-125376 filed on May 10, 2007, the content of which is hereby incorporated by reference into this application.

### BACKGROUND OF THE INVENTION

This invention relates to a computer system which includes a plurality of first computers operated by a user and a second computer coupled to the plurality of first computers via a network, and more particularly, to a technology of distributing information transmitted from a first computer to another first computer.

A great number of pieces of software are available to enable text communication (chatting) among many users. Such software uses an XMPP protocol method defined by an Internet engineering task force (IETF) or a session initiation protocol (SIP). The software realizes chatting by carrying out the following process.

First, each user selects an electronic conference to participate in. Next, an information terminal operated by each user transmits user's speech made at the electronic conference to a server which controls the electronic conference. Then, the server that controls the electronic conference distributes the received speech to information terminals operated by currently participating users.

An electronic conference system that uses an audio or a video is also realized by carrying out a process similar to that of chatting. Specifically, a server mixes speeches and videos of users participating in an electronic conference, and distributes mixed information to information terminals operated by the currently participating users.

JP H11-272577 A discloses an electronic conference system based on text chatting. In the electronic conference system disclosed therein, a server distributes conversation contents in which a user is interested to an information terminal operated by the user who does not participate in an electronic conference. According to this electronic conference system, each user enters an interesting keyword to reserve conversation notification. When a conversation matching the keyword entered by the user is held at the electronic conference, the server transmits conversation contents to an information terminal operated by the user irrespective of participation of the user in a conference room.

### SUMMARY OF THE INVENTION

According to a general electronic conference system, a conversation is transmitted only to an information terminal operated by a user who participates in an electronic conference. Thus, a user who does not participate in the electronic conference cannot grasp conversation contents of the electronic conference. Even if the user not participating in the electronic conference has useful information for the conversation contents or is interested in the conversation contents, the user cannot even know that a conversation has been held. As a result, the user participating in the electronic conference may lose a chance of obtaining useful information.

To solve the above-mentioned problem, the electronic conference system disclosed in JP 11-272577 A transmits conversation contents of the electronic conference to information terminals operated by users who do not participate in the electronic conference.

However, in the case of the electronic conference system disclosed in JP 11-272577 A, even if a user takes an interest in conversation contents of the electronic conference, the user finds it difficult to participate in the electronic conference where he has no acquaintances because of a strong psychological resistance.

This invention has been made in view of the above-mentioned problems, and is directed to a computer system which distributes information by taking a relation among users into consideration.

A representative aspect of this invention is as follows. That is, there is provided a computer system comprising a plurality of first computers operated by users and a second computer coupled to the plurality of first computers via a network. The second computer receives a group creation request from one of the plurality of first computers; creates a group to which one or more of the users belong based on the received group creation request; specifies, among users having relation to a user who operates the one of the plurality of first computers that transmitted the received group creation request, users not belonging to the created group as leakage destination users; and transmits information received from one of the plurality of first computers operated by one of the users belonging to the created group to first computers operated by the specified leakage destination users.

According to the exemplary embodiment of this invention, information can be distributed by taking a relation among the users into consideration.

### BRIEF DESCRIPTION OF THE DRAWINGS

The present invention can be appreciated by the description which follows in conjunction with the following figures, wherein:

FIG. 1 is an explanatory diagram showing an operation concept of a communication system in accordance with a first embodiment of this invention;

FIG. 2 is an explanatory diagram showing a participation screen displayed in an information terminal in accordance with the first embodiment of this invention;

FIG. 3 is an explanatory diagram showing a leakage screen displayed in an information terminal in accordance with the first embodiment of this invention;

FIG. 4 is a block diagram showing a physical configuration of the communication system in accordance with the first embodiment of this invention;

FIG. 5 is a block diagram showing a physical configuration of the multi-person conference control server, the personal-connection information management server, and the information terminal in accordance with the first embodiment of this invention;

FIG. 6 is a block diagram showing a functional configuration of the multi-person conference control server in accordance with the first embodiment of this invention;

FIG. 7 is a block diagram showing a functional configuration of the information terminal in accordance with the first embodiment of this invention;

FIG. 8 is a block diagram showing a functional configuration of the personal-connection information management server in accordance with the first embodiment of this invention;

FIG. 9 is an explanatory diagram showing a configuration of the conference participating user management table stored in the multi-person conference control server in accordance with the first embodiment of this invention;

FIG. 10 is an explanatory diagram showing a configuration of the conference information management table stored in the multi-person conference control server in accordance with the first embodiment of this invention;

FIG. 11 is an explanatory diagram showing a configuration of the leakage management table stored in the multi-person conference control server in accordance with the first embodiment of this invention;

FIG. 12 is an explanatory diagram showing a configuration of the personal-connection information table stored in the personal-connection information management server in accordance with the first embodiment of this invention;

FIG. 13 is a sequential diagram showing a process regarding an electronic conference of the communication system in accordance with the first embodiment of this invention;

FIG. 14 is a flowchart showing a leakage range deciding process at the time of conference room entry request reception of the multi-person conference control server in accordance with the first embodiment of this invention;

FIG. 15 is a flowchart showing a leakage process of the multi-person conference control server in accordance with the first embodiment of this invention;

FIG. 16 is a flowchart showing a leakage range deciding process of the multi-person conference control server at the reception time of a conference room exit request in accordance with the first embodiment of this invention;

FIG. 17 is an explanatory diagram showing a configuration of the presence information table stored by the multi-person conference control server in accordance with a second embodiment of this invention;

FIG. 18 is an explanatory diagram showing a configuration of the keyword designation management table stored by the multi-person conference control server in accordance with a third embodiment of this invention;

FIG. 19 is an explanatory diagram showing a configuration of the leakage policy management table stored by the multi-person conference control server in accordance with a fifth embodiment of this invention;

FIG. 20 is an explanatory diagram showing a configuration of the route information table stored in the information terminal in accordance with a sixth embodiment of this invention;

FIG. 21 is an explanatory diagram showing a process of the communication system in accordance with the sixth embodiment of this invention;

FIG. 22 is a sequential diagram showing the process of the communication system in accordance with the sixth embodiment of this invention;

FIG. 23 is a sequential diagram showing a process regarding an electronic conference of the communication system in accordance with a seventh embodiment of this invention;

FIG. 24 is a sequential diagram showing a process regarding an electronic conference of the communication system in accordance with an eighth embodiment of this invention;

FIG. 25 is an explanatory diagram showing a process of the communication system in accordance with a ninth embodiment of this invention;

FIG. 26 is a sequential diagram showing a process of the communication system in accordance with the ninth embodiment of this invention;

FIG. 27 is an explanatory diagram showing an operation concept of the communication system in accordance with a tenth embodiment of this invention; and

FIG. 28 is an explanatory diagram showing an operation concept of the communication system n accordance with the eleventh embodiment of this invention.

### DETAILED DESCRIPTION OF THE PREFERRED EMBODIMENTS

The preferred embodiments of this invention will be described below referring to the drawings.

### First Embodiment

A first embodiment is directed to a sequence of leakage of information held by each user or a conversation held between users based on a human relation. A conversation is established when a plurality of users make speeches.

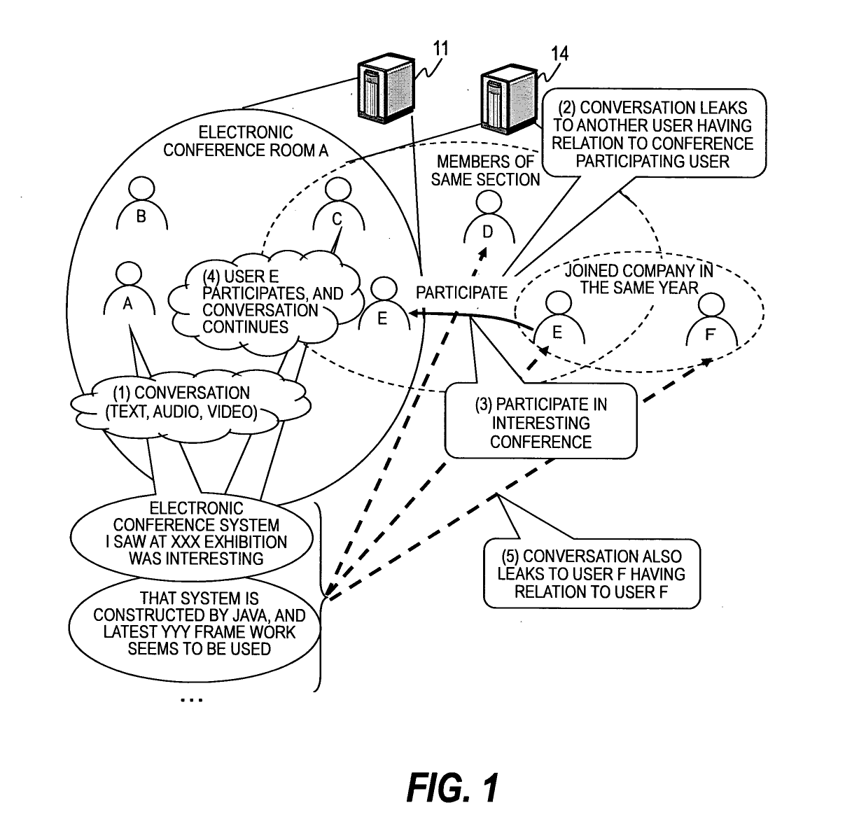

FIG. 1 illustrates an operation concept of a communication system according to the first embodiment of this invention.

The communication system includes a multi-person conference control server 11, a personal-connection information management server 14, and a plurality of information terminals. The information terminal is operated by a user. Thus, the information terminal may be referred to as a user who operates the information terminal below. In other words, a user A may mean an information terminal operated by the user A.

In FIG. 1, users A to C participate in an electronic conference A managed by the multi-person conference control server 11. The users A to C hold a conversion by using at least one of a text, an audio and a video. For example, the users A to C converse with one another by chatting based on a text.

The multi-person conference control server 11 leaks a conversation of the electronic conference A to users having human relations to those participating in the electronic conference A. In other words, the multi-person conference control server 11 leaks the conversation of the electronic conference A to users who have human relations to the users A to C. The human relation is a relation among members of the same section or employees who have joined a company in the same year. Any types of relations can be employed as long as they are relations among users. The human relation includes direct and indirect human relations. The indirect human relation is built via one or more other users.

In FIG. 1, the multi-person conference control server 11 leaks the conversation of the electronic conference A to users D and E belonging to the same section as that of the user C.

An example of a screen displayed in an information terminal operated by a user will be described.

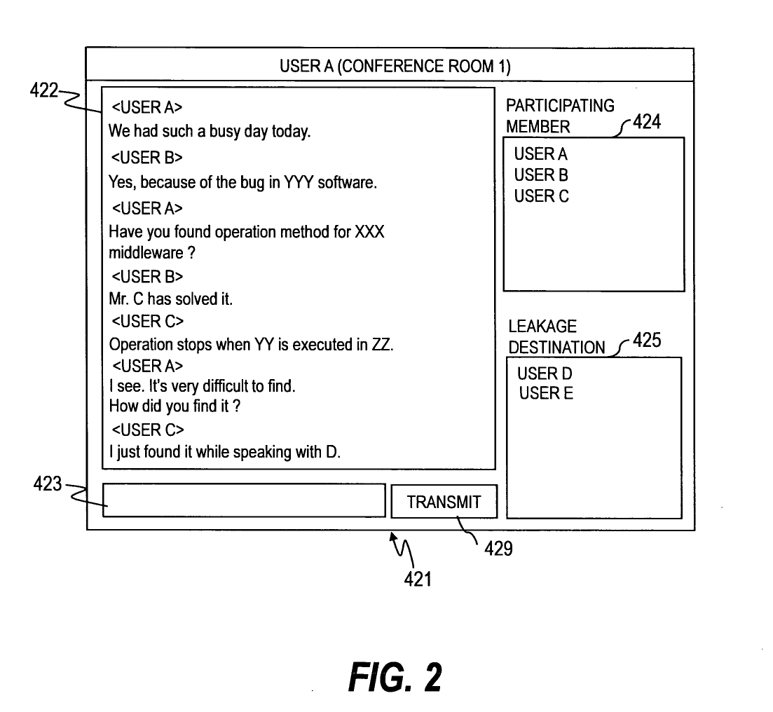

FIG. 2 illustrates a participation screen 421 displayed in an information terminal according to the first embodiment of this invention.

The participation screen 421 is displayed in an information terminal operated by a user who participates in an electronic conference. In a status shown in FIG. 1, the participation screen 421 can be displayed in the information terminals operated by the users A to C.

The participation screen 421 includes a conversation content section 422, a participation member section 424, leakage destination section 425, a speech input section 423, and a transmission button 429.

The conversation content section 422 displays a conversion of an electronic conference. The participation member section 424 displays a name of a user who participates in the electronic conference. The leakage destination section 425 displays a name of a user to whom the conversation of the electronic conference leaks. Accordingly, the leakage destination section 425 displays a name of a user who has a human relation to the user participating in the electronic conference.

A user enters a speech of the electronic conference to the speech input section 423. Upon operation of the transmission button 429 by a user, an information terminal transmits a speech entered to the speech input section 423 to the multi-person conference control server 11. The multi-person conference control server 11 distributes the speech received from the information terminal to information terminals operated by the other users who participate in the electronic conference. Each information terminal displays the speech received from the multi-person conference control server 11 in the conversation content section 422 included in the participation screen 421.

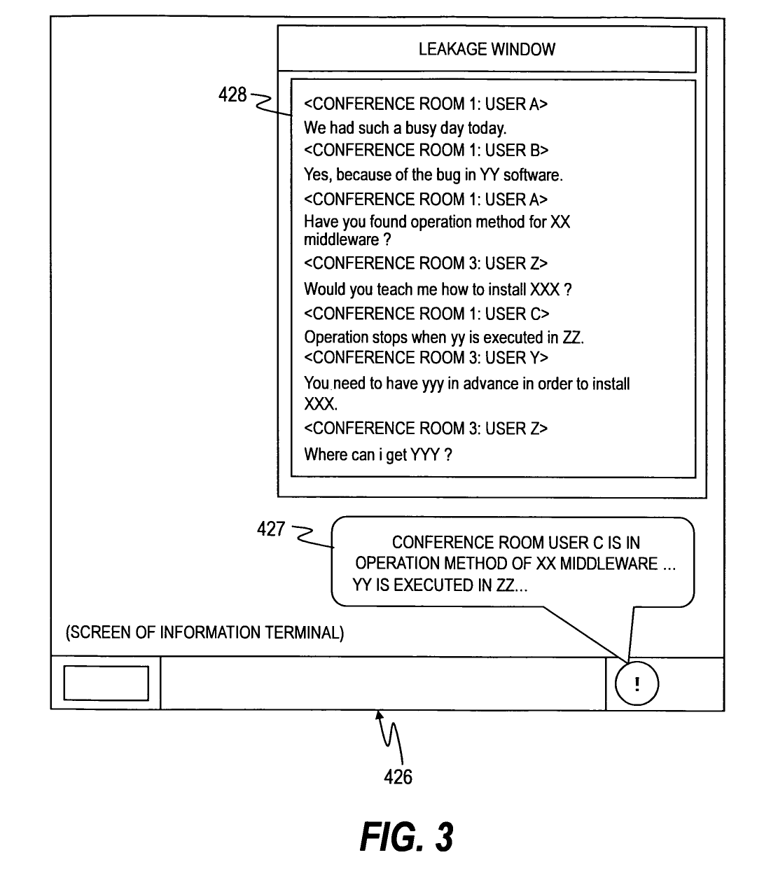

FIG. 3 illustrates a leakage screen 426 displayed in an information terminal according to the first embodiment of this invention.

The leakage screen 426 is displayed in an information terminal operated by a user to whom a conversation of an electronic conference leaks. Accordingly, the leakage screen 426 is displayed in an information terminal operated by a user who has a human relation to a user participating in the electronic conference.

According to the conventional technology, the information terminal operated by the user not participating in the electronic conference cannot receive contents of the conversation of the electronic conference. According to the embodiment, however, the information terminal operated by the user who has a human relation to the user participating in the electronic conference can receive contents of a conversation of the electronic conference. The information terminal operated by the user who has a human relation to the user participating in the electronic conference displays the received conversation contents as the leakage screen 426.

Specifically, the multi-person conference control server 11 obtains personal-connection information from the personal-connection information management server 14. The personal-connection information indicates a human relation among users. The multi-person conference control server 11 sets an information terminal operated by a user who becomes a leakage destination based on the obtained personal-connection information. The multi-person conference control server 11 distributes the conversation contents of the electronic conference to the set information terminal.

The leakage screen 426 includes a leakage section 427 or 428. The leakage section 427 or 428 displays a conversation of the electronic conference.

Referring back to FIG. 1, the user E listens to a conversation leaked from the electronic conference A as he or she belongs to the same section as that of the user C participating in the electronic conference. Then, it is presumed that the user E takes an interest in contents of the conversion of the electronic conference A to participate in the electronic conference A.

The multi-person conference control server 11 obtains personal-connection information of the user E from the personal-connection information management server 14. Thus, the multi-person conference control server 11 understands that the users E and F are employees who have joined a company in the same year. The multi-person conference control server 11 leaks the conversation of the electronic conference A to the user F who has a human relation to the user E.

As described above, the multi-person conference control server 11 can leak the contents of the conversation of the electronic conference to the user who has a human relation to at least one of the users participating in the electronic conference. Thus, as users not participating in the electronic conference can know the contents of the electronic conference, a conversation broads.

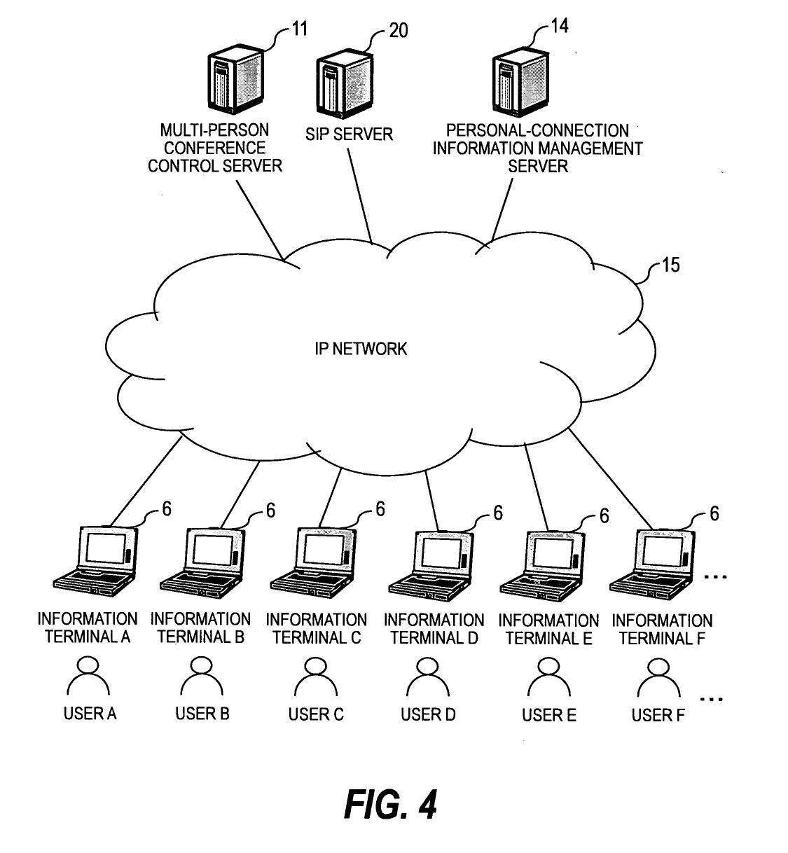

FIG. 4 is a block diagram of a physical configuration of the communication system according to the first embodiment of this invention.

The communication system includes the multi-person conference control server 11, a SIP server 20, the personal-connection information management server 14, an IP network 15, and a plurality of information terminals 6.

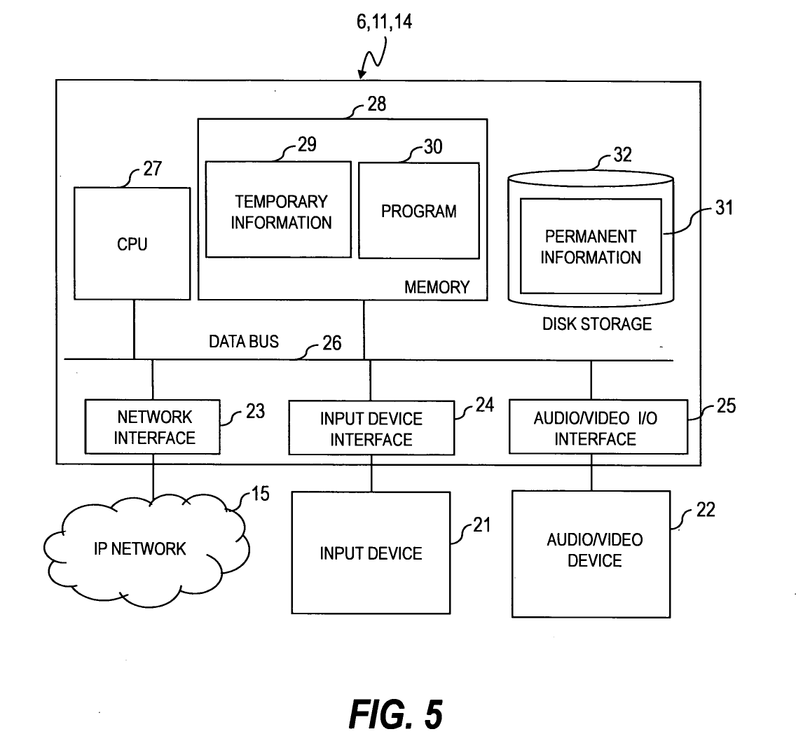

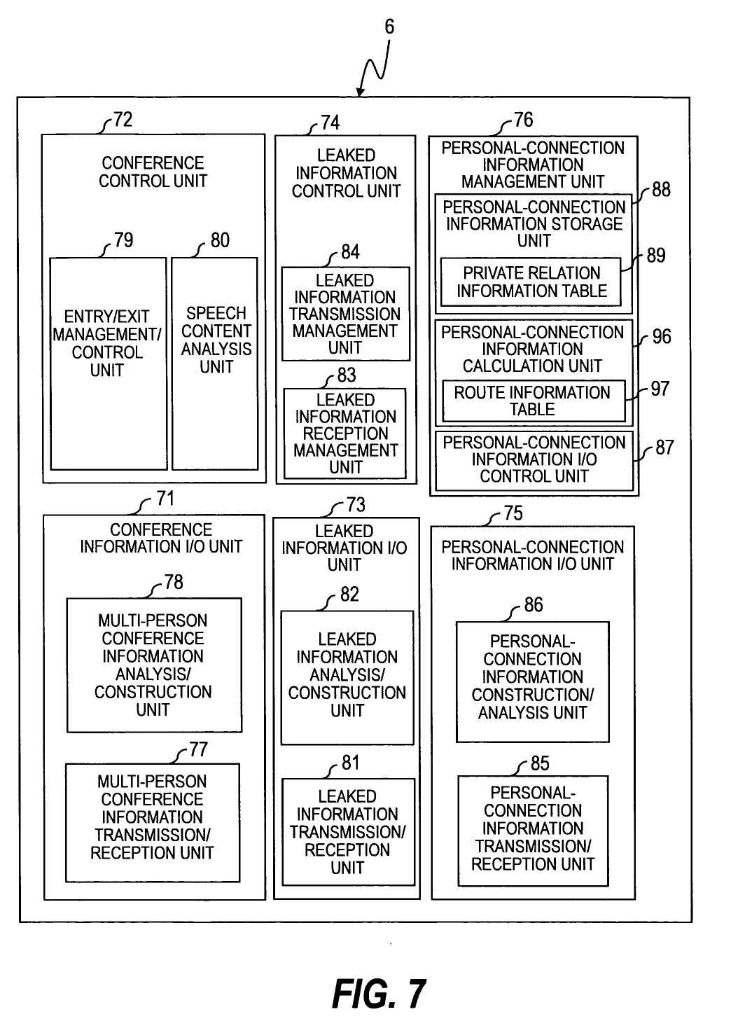

The information terminal 6 is a computer operated by each user. An information terminal 6A is an information terminal 6 operated by the user A. Similarly, information terminals B6 to F6 are information terminals 6 operated by the users B to F, respectively. A physical configuration of the information terminal 6 will be described below in detail referring to FIG. 5. A functional configuration of the information terminal 6 will be described below in detail referring to FIG. 7.

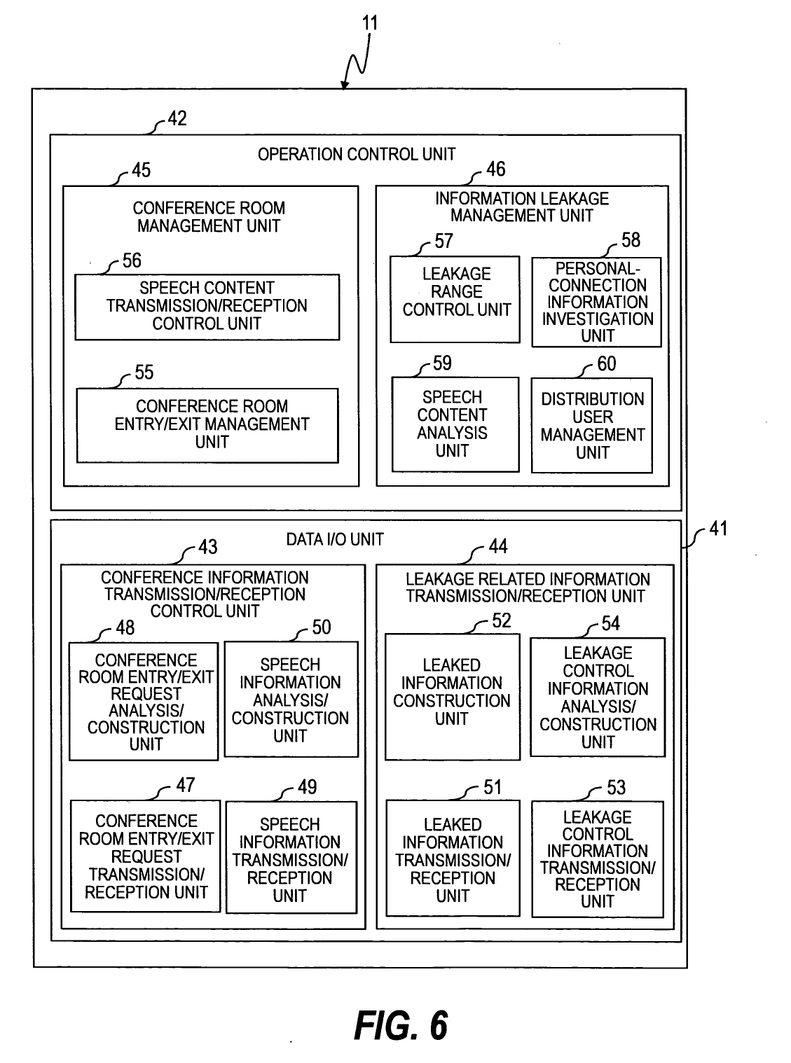

The multi-person conference control server 11 is a computer for controlling an electronic conference in which users participate. A physical configuration of the multi-person conference control server 11 will be described below in detail referring to FIG. 5. A functional configuration of the multi-person conference control server 11 will be described below in detail referring to FIG. 6.

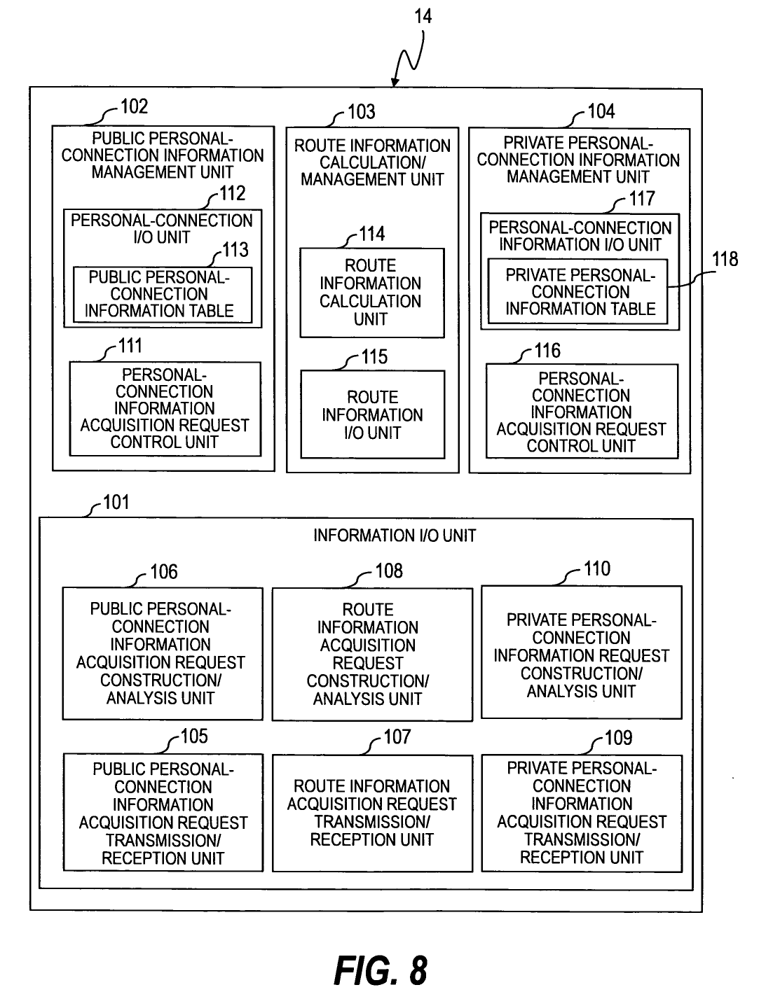

The personal-connection information management server 14 is a computer for storing personal-connection information. A physical configuration of the personal-connection information management server 14 will be described below in detail referring to FIG. 5. A functional configuration of the personal-connection information management server 14 will be described below in detail referring to FIG. 8.

The personal-connection information management server 14 may store pregenerated personal-connection information, or generate personal-connection information based on various pieces of information to store it. Various pieces of information used for generating the personal-connection information include an organizational chart of a company, a year of joining a company, information of belonging to club activities, information of belonging to committees, information analyzing electronic mail transmitted/received among information terminals, and joint-authorship information of documents. According to the embodiment, personal-connection information stored by the personal-connection information management server 14 may be generated by any method.

The SIP server 20 is a computer for controlling transmission/reception of character information, audio information, or video information of an electronic conference. The SIP is a protocol for controlling a status from a start to an end of communication between users including a text, an audio or a video, and standardized by the IETF. The protocol for controlling the transmission/reception of the character information, the audio information, or the video information of the electronic conference is SIP. However, a protocol other than the SIP may be used.

The IP network 15 intercouples the multi-person conference control server 11, the SIP server 20, the personal-connection information management server 14, and the information terminal 6.

FIG. 5 is a block diagram of a physical configuration of the multi-person conference control server 11, the personal-connection information management server 14, and the information terminal 6 according to the first embodiment of this invention.

Each of the multi-person conference control server 11, the personal-connection information management server 14, and the information terminal 6 includes a CPU 27, a memory 28, a disk storage 32, a data bus 26, a network interface 23, an input device interface 24, and an audio/video I/O interface 25. Each of the multi-person conference control server 11, the personal-connection information management server 14, and the information terminal 6 may further include an input unit, an output unit, and a display unit.

The data bus 26 intercouples the CPU 27, the memory 28, the disk storage 32, the network interface 23, the input device interface 24, and the audio/video I/O interface 25.

The CPU 27 executes a program 30 stored in the memory 28 to realize each unit. Accordingly, the CPU 27 carries out various processes.

The memory 28 stores the program 30 executed by the CPU 27 and information 29 necessary for the CPU 27. The disk storage 32 stores various pieces of information 31 including a program and a table.

The network interface 23 is coupled to the IP network 15.

The input device interface 24 is coupled to an input device 21. The input device is, for example, a mouse or a keyboard, and transmits information entered by a user to the CPU 27.

The audio/video I/O interface 25 is coupled to an audio/video device 22. The audio/video device 22 is, for example, a speaker, a microphone, or a PC camera, and inputs/outputs an audio or a video.

FIG. 6 is a block diagram of a functional configuration of the multi-person conference control server 11 according to the first embodiment of this invention.

The multi-person conference control server 11 includes an operation control unit 42 and a data I/O unit 41. The operation control unit 42 and the data I/O unit 41 may be realized as a software by the CPU 27 which executes the program 30, or as a hardware.

The operation control unit 42 controls an overall operation of the multi-person conference control server 11. The operation control unit 42 includes a conference room management unit 45 and an information leakage management unit 46.

The conference room management unit 45 manages an electronic conference room. The conference room management unit 45 includes a speech content transmission/reception control unit 56 and a conference room entry/exit management unit 55.

The speech content transmission/reception control unit 56 controls transmission/reception of speeches made at an electronic conference. Specifically, the speech content transmission/reception control unit 56 specifies a user participating in the electronic conference as a user to whom a speech of the electronic conference is transmitted. The conference room entry/exit management unit 55 manages entry/exit of each user into/from the conference room.

The information leakage management unit 46 manages leakage of a speech of the electronic conference. The information leakage management unit 46 includes a leakage range control unit 57, a personal-connection information investigation unit 58, a speech content analysis unit 59, and a distribution user management unit 60.

The leakage range control unit 57 sets a leakage range of a conversation of the electronic conference. In other words, the leakage range control unit 57 sets a user to whom a speech of the electronic conference leaks.

The distribution user management unit 60 manages an information terminal 6 operated by the user set as the leakage destination by the leakage range control unit 57 as a distribution destination of a speech of the electronic conference.

The personal-connection information investigation unit 58 obtains personal-connection information from the personal-connection information management server 14. The speech content analysis unit 59 analyzes contents of a speech of the electronic conference. The leakage range control unit 57 sets a leakage range of the conversation of the electronic conference based on the personal-connection information obtained by the personal-connection information investigation unit 58 and the speech contents analyzed by the speech content analysis unit 59.

The data I/O unit 41 transmits/receives various pieces of information. The data I/O unit 41 includes a conference information transmission/reception control unit 43 and a leakage related information transmission/reception control unit 44.

The conference information transmission/reception control unit 43 transmits/receives information regarding an electronic conference. The conference information transmission/reception control unit 43 includes a conference room entry/exit request transmission/reception unit 47, a conference room entry/exit request analysis/construction unit 48, a speech information transmission/reception unit 49, and a speech information analysis/construction unit 50.

The conference room entry/exit request transmission/reception unit 47 receives a conference room entry request and a conference room exit request from the information terminal 6. The conference room entry/exit request transmission/reception unit 47 transmits conference room entry information and conference room exit information to the information terminal 6. The conference room entry request requests an entry of a user who operates an information terminal 6 of a transmission source of the conference room entry request to the electronic conference room. The conference room exit request requests an exit of the user who operates the information terminal 6 of the transmission source of the conference room entry request from the electronic conference room. The conference entry information notifies an entry of a new user to the electronic conference room. The conference exit information notifies an exit of a user who has entered the electronic conference room.

The conference room entry/exit request analysis/construction unit 48 analyzes the conference room entry request and the conference room exit request received by the conference room entry/exit request transmission/reception unit 47. The conference room entry/exit request analysis/construction unit 48 constructs conference room entry information and conference room exit information transmitted by the conference room entry/exit request transmission/reception unit 47.

The speech information transmission/reception unit 49 transmits/receives a speech of the electronic conference. For example, the speech information transmission/reception unit 49 transmits/receives a speech of the electronic conference as a chat message. The speech information analysis/construction unit 50 analyzes the speech received by the speech information transmission/reception unit 49. The speech information analysis/construction unit 50 constructs a speech transmitted by the speech information transmission/reception unit 49.

The leakage related information transmission/reception control unit 44 transmits/receives information regarding leakage of a speech of the electronic conference. The leakage related information transmission/reception control unit 44 includes a leaked information transmission unit 51, a leaked information construction unit 52, a leakage control information transmission/reception unit 53, and a leakage control information analysis/construction unit 54.

The leaked information construction unit 52 constructs leaked information transmitted to an information terminal 6 of a leakage destination. Specifically, among speeches of the electronic conference, a speech to be leaked is specified, and the specified speech is constructed as leaked information. The leaked information transmission unit 51 transmits the leaked information constructed by the leaked information construction unit 52 to an information terminal 6 operated by a user of a leakage destination.

The leakage control information analysis/construction unit 54 analyzes and constructs information for setting a leakage range of a conversation of the electronic conference. The information for setting the leakage range of the conversation of the electronic conference is, for example, personal-connection information. The leakage control information transmission/reception unit 53 transmits/receives the information for setting the leakage range of the conversation of the electronic conference.

The multi-person conference control server 11 stores a conference participating user management table 211, a conference information management table 214, and a leakage management table 231.

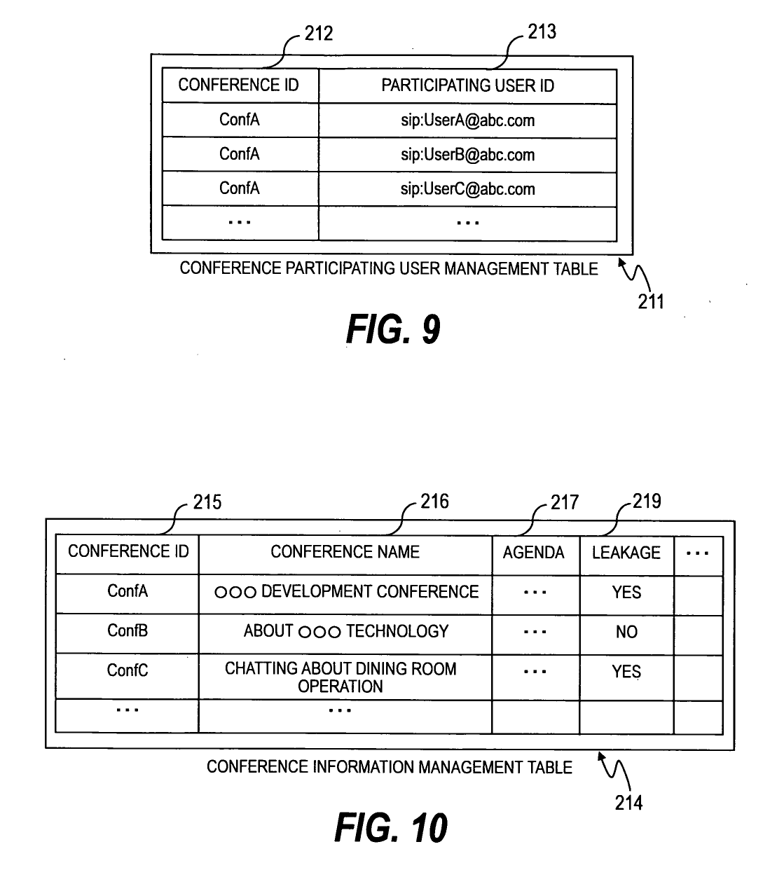

The conference participating user management table 211 indicates users participating in the electronic conference. The conference participating user management table 211 will be described below in detail referring to FIG. 9.

The conference information management table 214 indicates information regarding the electronic conference. The conference information management table 214 will be described below in detail referring to FIG. 10.

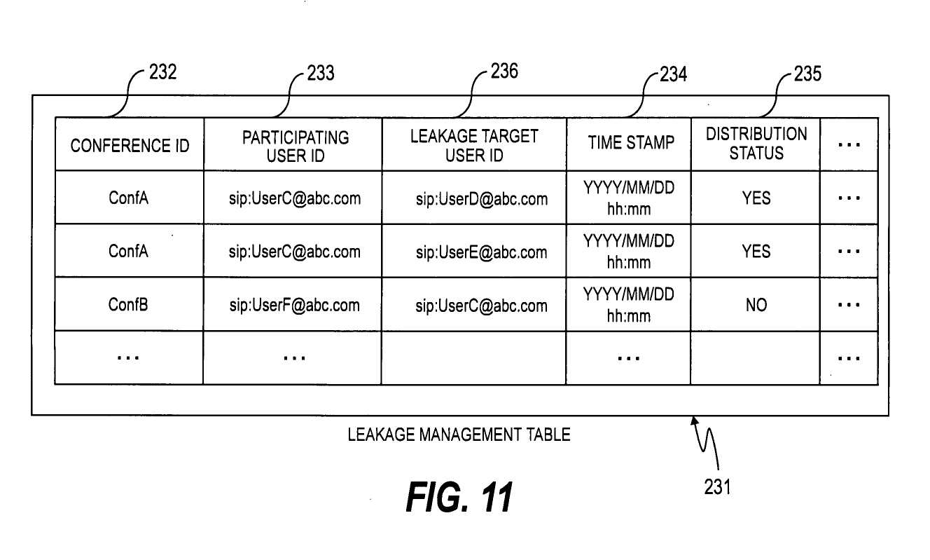

The leakage management table 231 indicates information regarding leakage of the conversation of the electronic conference. The leakage management table 231 will be described below in detail referring to FIG. 11.

FIG. 7 is a block diagram of a functional configuration of the information terminal 6 according to the first embodiment of this invention.

The information terminal 6 includes a conference control unit 72, a conference information I/O unit 71, a leaked information control unit 74, a leaked information I/O unit 73, a personal-connection information management unit 76, and a personal-connection information I/O unit 75. The conference control unit 72, the conference information I/O unit 71, the leaked information control unit 74, the leaked information I/O unit 73, the personal-connection information management unit 76, and the personal-connection information I/O unit 75 may be realized as a software by the CPU 27 which executes the program 30, or as a hardware.

The conference control unit 72 carries out a process regarding an electronic conference. The conference control unit 72 includes an entry/exit management/control unit 79 and a speech content analysis unit 80.

The entry/exit management/control unit 79 stores participation information of a user in the electronic conference. The entry/exit management/control unit 79 controls transmission of a conference room entry request and a conference room exit request. The speech content analysis unit 80 analyzes a speech made at the electronic conference. The speech content analysis unit 80 displays the speech of the electronic conference in a screen. When the information terminal 6 generates speech leakage, a result of analysis of the speech content analysis unit 80 is used for setting a leakage range.

The conference information I/O unit 71 transmits/receives information regarding the electronic conference. The conference information I/O unit 71 includes a multi-person conference information analysis/construction unit 78 and a multi-person conference information transmission/reception unit 77.

The multi-person conference information transmission/reception unit 77 transmits/receives information regarding the electronic conference. The information regarding the electronic conference is a speech at the electronic conference, a conference room entry request, a conference room exit request, conference room entry information, or conference room exit information.

The multi-person conference information analysis/construction unit 78 constructs a conference room entry request and a conference room exit request transmitted by the multi-person conference information transmission/reception unit 77. The multi-person conference information analysis/construction unit 78 constructs a speech of the electronic conference as a chat message. The multi-person conference information analysis/construction unit 78 analyzes a speech, conference room entry information, and conference room exit information received by the multi-person conference information transmission/reception unit 77.

The leaked information control unit 74 controls transmission/reception of leaked information generated at the electronic conference. The leaked information control unit 74 includes a leaked information transmission management unit 84 and a leaked information reception management unit 83.

The leaked information transmission management unit 84 controls transmission of leaked information when the information terminal 6 generates conversation leakage. The leaked information reception management unit 83 controls reception of leaked information generated at the electronic conference. Then, the leaked information reception management unit 83 displays the received leaked information on the screen.

The leaked information I/O unit 73 transmits/receives the leaked information generated at the electronic conference. The leaked information I/O unit 73 includes a leaked information analysis/construction unit 82 and a leaked information transmission/reception unit 81.

The leaked information transmission/reception unit 81 transmits/receives the leaked information generated at the electronic conference. The leaked information analysis/construction unit 82 analyzes the leaked information received by the leaked information transmission/reception unit 81. When the information terminal 6 generates conversation leakage, the leaked information analysis/construction unit 82 constructs leaked information to be transmitted by the leaked information transmission/reception unit 81.

The personal-connection information management unit 76 manages personal-connection information regarding a user who operates the information terminal 6. The personal-connection information management unit 76 includes a personal-connection storage unit 88, a personal-connection information calculation unit 96, and a personal-connection information I/O control unit 87.

The personal-connection storage unit 88 stores the personal-connection information regarding the user who operates the information terminal 6 in a private relation information table 89. The private relation information table 89 indicates the personal-connection information regarding the user who operates the information terminal 6.

The personal-connection information calculation unit 96 generates personal-connection information regarding the user who operates the information terminal 6 based on various pieces of information. The personal-connection information calculation unit 96 calculates a distance between the user who operates the information terminal 6 and the other user. The personal-connection information calculation unit 96 stores the calculated distance between the users in a route information table 97. The route information table 97 indicates a distance between the user who operates the information terminal 6 and the other user.

According to the embodiment, the distance between the users is the number of human relations used to reach another user from one user. For example, when users A and B have a human relation, a distance between the users A and B is “1”. When the users A and B have a human relation, and the users B and C have a human relation, a distance between the users A and C is “2”. Other definitions may be used for distances between users.

The personal-connection information I/O unit 87 controls input/output of personal-connection information regarding the user who operates the information terminal 6.

The personal-connection information I/O unit 75 controls transmission/reception of the personal-connection information. The personal-connection information I/O unit 75 includes a personal-connection information transmission/reception unit 85 and a personal-connection information construction/analysis unit 86.

The personal-connection information transmission/reception unit 85 transmits the personal-connection information. The personal-connection information construction/analysis unit 86 analyzes the personal-connection information received by the personal-connection information transmission/reception unit 85. The personal-connection information construction/analysis unit 86 constructs personal-connection information to be transmitted by the personal-connection information transmission/reception unit 85.

FIG. 8 is a block diagram of a functional configuration of the personal-connection information management server 14 according to the first embodiment of this invention.

The personal-connection information management server 14 includes a public personal-connection information management unit 102, a route information calculation/management unit 103, a private personal-connection information management unit 104, and an information I/O unit 101. The public personal-connection information management unit 102, the route information calculation/management unit 103, the private personal-connection information management unit 104, and the information I/O unit 101 may be realized as a software by the CPU 27 which executes the program 30, or as a hardware.

The public personal-connection information management unit 102 manages public personal-connection information indicating a public human relation. The public personal-connection information is generated based on an organizational chart or a year of joining a company. In other words, the public personal-connection information is information which has already been disclosed to the outside and causes no privacy problem when disclosed to the outside. The public personal-connection information management unit 102 includes a personal-connection information I/O unit 112 and a personal-connection information acquisition request control unit 111.

The personal-connection information I/O unit 112 updates a public personal-connection information table 113. The public personal-connection information table 113 manages a public human relation.

The personal-connection information acquisition request control unit 111 judges whether or not to respond to an acquisition request of public personal-connection information. Accordingly, the personal-connection information acquisition request control unit 111 prevents leakage of public personal-connection information.

The private personal-connection information management unit 104 manages private personal-connection information indicating a private human relation. The private personal-connection information is, for example, personal-connection information generated based on electronic mail transmission/reception information. In other words, the private personal-connection information should not be disclosed to the outside for privacy. The private personal-connection information management unit 104 includes a personal-connection information I/O unit 117 and a personal-connection information acquisition request control unit 116.

The personal-connection information I/O unit 117 updates a private personal-connection information table 118. The private personal-connection information table 118 manages a private human relation. The private personal-connection information table 118 is similar in configuration to the public personal-connection information table 113. Accordingly, the public personal-connection information table 113 and the private personal-connection information table 118 may be integrated into one table, or provided as different tables.

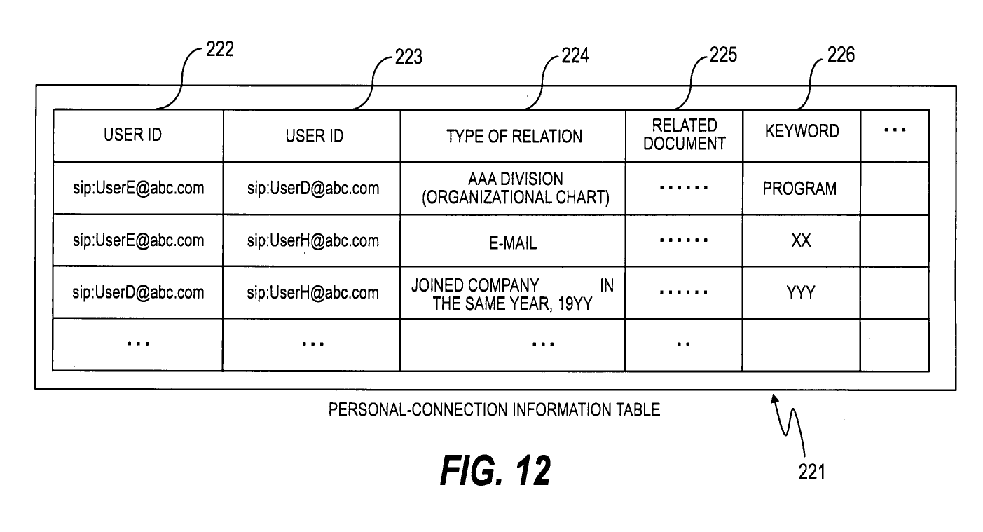

The embodiment is directed to a case where the public personal-connection information table 113 and the private personal-connection information table 118 are integrated into one table (personal-connection information table 221). The personal-connection information table 221 will be described below in detail referring to FIG. 12.

A personal-connection information acquisition request control unit 119 judges whether or not to respond to an acquisition request of private personal-connection information. Accordingly, the personal-connection information acquisition request control unit 111 prevents leakage of the private personal-connection information.

When there is no need to manage any private human relation, the private personal-connection information management unit 104 is omitted.

The route information calculation/management unit 103 manages route information. The route information calculation/management unit 103 includes a route information calculation unit 114 and a route information I/O unit 115. The route information indicates a distance between users.

The route information calculation unit 114 calculates route information based on the public personal-connection information table 113 and the private personal-connection information table 118. The route information calculation unit 114 may calculate a route each time route information is requested or store precalculated route information.

The route information I/O unit 115 outputs the route information calculated by the route information calculation unit 114.

The information I/O unit 101 transmits/receives various pieces of information. The information I/O unit 101 includes a public personal-connection information acquisition request construction/analysis unit 106, a public personal-connection information acquisition request transmission/reception unit 105, a route information acquisition request construction/analysis unit 108, a route information acquisition request transmission/reception unit 107, a private personal-connection information acquisition request construction/analysis unit 110, and a private personal-connection information acquisition request transmission/reception unit 109.

The public personal-connection information acquisition request transmission/reception unit 105 transmits/receives an acquisition request of public personal-connection information. The public personal-connection information acquisition request transmission/reception unit 105 transmits/receives a response to the acquisition request of the public personal-connection information. The public personal-connection information acquisition request construction/analysis unit 106 analyzes the acquisition request of the public personal-connection information and the response received by the public personal-connection information acquisition request transmission/reception unit 105. The public personal-connection information acquisition request construction/analysis unit 106 constructs an acquisition request of public personal-connection information and a response to be transmitted by the public personal-connection information acquisition request transmission/reception unit 105.

The private personal-connection information acquisition request transmission/reception unit 109 transmits/receives an acquisition request of private personal-connection information. The private personal-connection information acquisition request transmission/reception unit 109 transmits/receives a response to the acquisition request of the private personal-connection information. The private personal-connection information acquisition request construction/analysis unit 110 analyzes the acquisition request of the private personal-connection information and the response received by the private personal-connection information acquisition request transmission/reception unit 109. The private personal-connection information acquisition request construction/analysis unit 110 constructs an acquisition request of private personal-connection information and a response to be transmitted by the private personal-connection information acquisition request transmission/reception unit 109.

The route information acquisition request transmission/reception unit 107 transmits/receives an acquisition request of route information. The route information acquisition request transmission/reception unit 107 transmits/receives a response to the acquisition request of the route information. The route information acquisition request construction/analysis unit 108 analyzes the acquisition request of the route information and the response received by the route information acquisition request transmission/reception unit 107. The route information acquisition request construction/analysis unit 108 constructs an acquisition request of route information and a response to be transmitted by the route information acquisition request transmission/reception unit 107.

FIG. 9 illustrates a configuration of the conference participating user management table 211 stored in the multi-person conference control server 11 according to the first embodiment of this invention.

The conference participating user management table 211 includes a conference ID 212 and a participating user ID 213.

The conference ID 212 is a unique identifier of an electronic conference managed by the multi-person conference control server 11. The participating user ID 213 is a unique identifier of a user participating in the electronic conference identified by the conference ID 212 of a record.

FIG. 10 illustrates a configuration of the conference information management table 214 stored in the multi-person conference control server 11 according to the first embodiment of this invention.

The conference information management table 214 includes a conference ID 215, a conference name 216, an agenda 217, and a leakage flag 219.

The conference ID 215 is a unique identifier of an electronic conference managed by the multi-person conference control server 11. The conference name 216 is a name of the electronic conference identified by the conference ID 215 of a record. The agenda 217 is an agenda of the electronic conference identified by the conference ID 215 of the record. The leakage flag 219 indicates whether or not to leak conversations of the electronic conference identified by the conference ID 215 of the record. In other words, the leakage flag 219 indicates a policy regarding conversation leakage of the electronic conference identified by the conference ID 215 of the record.

FIG. 11 illustrates a configuration of the leakage management table 231 stored in the multi-person conference control server 11 according to the first embodiment of this invention.

The leakage management table 231 includes a conference ID 232, a participating user ID 233, a leakage target user ID 236, a time stamp 234, and a distribution status 235.

The conference ID 232 is a unique identifier of an electronic conference managed by the multi-person conference control server 11. The participating user ID 233 is a unique identifier of a user participating in the electronic conference identified by the conference ID 232 of a record.

The leakage target user ID 236 is a unique identifier of a user who becomes a conversation leakage destination of the electronic conference identified by the conference ID 232 of the record. A user identified by the leakage target user ID 236 has a human relation to the user identified by the participating user ID 233 of the record.

The time stamp 234 indicates exit time of the user identified by the participating user ID 233 of the record from the electronic conference identified by the conference ID 232 of the record.

The distribution status 235 indicates whether a conversation of the electronic conference identified by the conference ID 232 of the record has been distributed to the information terminal 6 operated by the user identified by the leakage target user ID 236 of the record. In other words, the distribution status 235 indicates whether the conversation of the electronic conference identified by the conference ID 232 of the record has leaked to the user identified by the leakage target user ID 236 of the record.

The distribution status 235 may also indicate limited leakage of a conversation of the electronic conference identified by the conference ID 232 of the record to the user identified by the leakage target user ID 236 of the record. When the distribution status 235 indicates limited leakage of a conversation of the electronic conference, while the user identified by the participating user ID 233 of the record has exited from the electronic conference, the conversation of the electronic conference leaks to the user identified by the leakage target user ID 236 of the record.

According to the embodiment, for a certain period from the exit time of the user identified by the participating user ID 233 from the electronic conference, the conversation of the electronic conference leaks to the user identified by the leakage target user ID 236 of the record. Thus, the leakage of the conversation to the user identified by the leakage target user ID 236 does not stop suddenly.

FIG. 12 illustrates a configuration of the personal-connection information table 221 stored in the personal-connection information management server 14 according to the first embodiment of this invention.

The personal-connection information table 221 includes user ID's 222 and 223, a type of relation 224, a related document 225, and a keyword 226.

Each of the user ID's 222 and 223 is a unique identifier of a user who operates the information terminal 6. Users respectively identified by the user ID's 222 and 223 have a human relation to each other.

The type of relation 224 indicates a type of a human relation between the users identified by the user ID's 222 and 223, respectively.

The related document 225 indicates contents of a document regarding both users identified by the user ID's 222 and 223, respectively. For example, the related document 225 indicates contents of electronic mail transmitted/received between the users identified by the user ID's 222 and 223, respectively. The related document 225 indicates an outline of a report coauthored by the users identified by the user ID's 222 and 223, respectively.

The keyword 226 is a character string regarding both users identified by the user ID's 222 and 223, respectively. For example, the keyword 226 is a character string obtained by analyzing the related document 225 of the record.

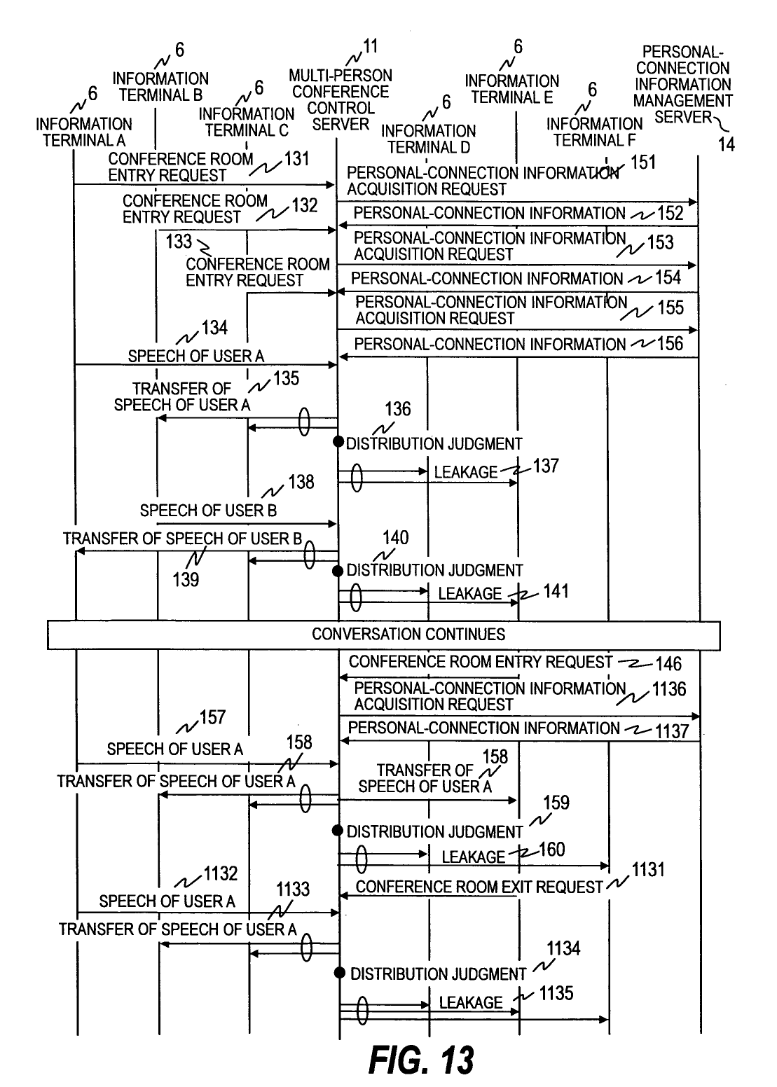

FIG. 13 is a sequential diagram of a process regarding an electronic conference of the communication system according to the first embodiment of this invention.

The sequential diagram illustrates a process when users have a human relation similar to that shown in FIG. 1.

First, the information terminal A6 operated by the user A transmits a conference room entry request to the multi-person conference control server 11 (131).

Upon reception of the conference room entry request, the multi-person conference control server 11 analyzes the received conference room entry request. Accordingly, the multi-person conference control server 11 specifies a conference requested for participation, and a user who has requested participation. In this case, the multi-person conference control server 11 specifies the user A who operates the information terminal A6 of a transmission source of the conference room entry request as a user who has requested participation.

The multi-person conference control server 11 updates the conference participating user management table 211 shown in FIG. 9 based on the specified conference and the specified user.

Specifically, the multi-person conference control server 11 adds a new record to the conference participating user management table 211. The multi-person conference control server 11 stores an identifier of the specified conference in a conference ID 212 of the new record. The multi-person conference control server 11 stores an identifier of the specified user in a participating user ID 213 of the new record.

The multi-person conference control server 11 may update the conference information management table 214 shown in FIG. 10 based on the received conference entry request. The conference information management table 214 may be updated by any method. For example, the conference information management table 214 is updated according to a request from an administrator of the multi-person conference control server 11 or a user participating in a conference.

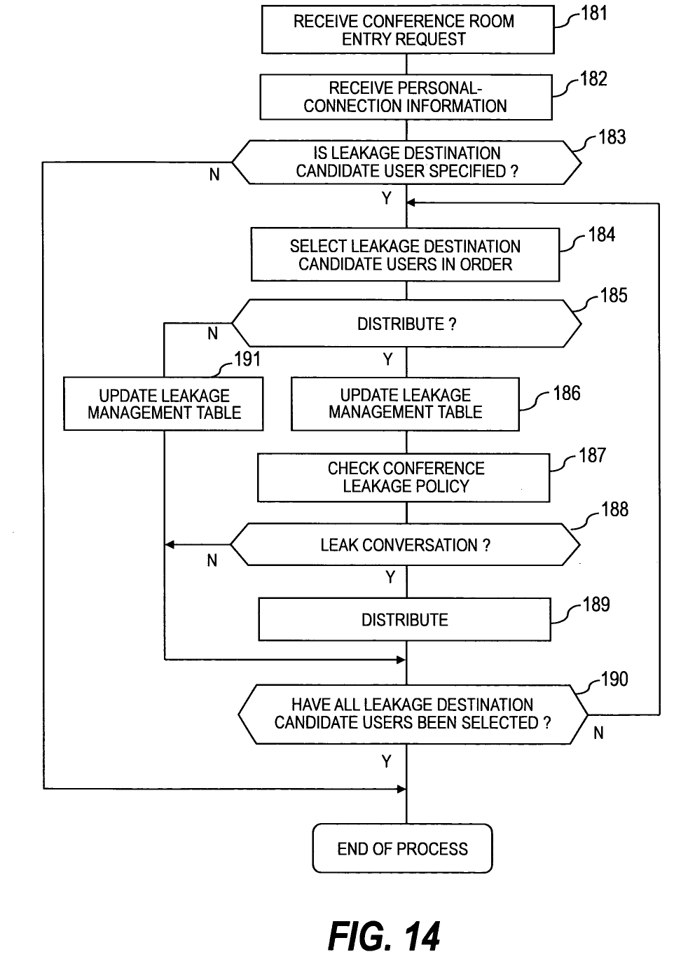

Then, the multi-person conference control server 11 carries out a leakage range deciding process at the time of reception of the conference room entry request. The leakage range deciding process at the time of reception of the conference room entry request will be described below in detail referring to FIG. 14.

The multi-person conference control server 11 transmits a personal-connection information acquisition request containing the identifier of the user specified in the step 131 to the personal-connection information management server 14 (151). Accordingly, the multi-person conference control server 11 requests acquisition of personal-connection information containing a list of identifiers of all users present within a predetermined distance from the user specified in the step 131. In the sequential diagram, a predetermined distance is “1”.

The multi-person conference control server 11 obtains personal-connection information containing no user identifier (152). Thus, the multi-person conference control server 11 does not change a conversation distribution destination of the specified electronic conference.

The information terminal B6 operated by the user B transmits a conference room entry request to the multi-person conference control server 11 (132).

Upon reception of the conference room entry request, the multi-person conference control server 11 analyzes the received conference room entry request. Accordingly, the multi-person conference control server 11 specifies a conference requested for participation and a user who has requested participation. The multi-person conference control server 11 updates the conference participating user management table 211 shown in FIG. 9.

The multi-person conference control server 11 carries out a leakage range deciding process of FIG. 14 at the time of reception of the conference room entry request.

The multi-person conference control server 11 transmits a personal-connection information acquisition request containing an identifier of the user specified in the step 132 to the personal-connection information management server 14 (153).

The multi-person conference control server 11 obtains personal-connection information containing no user identifier (154). Accordingly, the multi-person conference control server 11 does not change a conversation distribution destination of the specified electronic conference.

The information terminal C6 operated by the user C transmits a conference room entry request to the multi-person conference control server 11 (133).

Upon reception of the conference room entry request, the multi-person conference control server 11 analyzes the received conference room entry request. Accordingly, the multi-person conference control server 11 specifies a conference requested for participation and a user who has requested participation. The multi-person conference control server 11 updates the conference participating user management table 211 shown in FIG. 9.

The multi-person conference control server 11 carries out a leakage range deciding process of FIG. 14 at the time of reception of the conference room entry request.

The multi-person conference control server 11 transmits a personal-connection information acquisition request containing an identifier of the user specified in the step 133 to the personal-connection information management server 14 (155).

The multi-person conference control server 11 obtains personal-connection information containing identifies of users D and E (156). The multi-person conference control server 11 sets the users D and E as leakage destination users. In other words, the multi-person conference control server 11 decides to distribute a conversation of the electronic conference specified in the step 133 to the information terminals D6 and E6 operated by the users D and E, respectively. Accordingly, the multi-person conference control server 11 leaks the conversation of the electronic conference to the users D and E.

In reality, for distribution of a conversation to a newly set leakage destination user, permission may have to be obtained from users currently present in the conference room. In this case, after the step 133, an inquiry is made to each user present in the conference room about permission of distribution of conversation contents to the users D and E who are new leakage destination users. After acquisition of permission from all the users, distribution of conversation contents to the users D and E is started.

The information terminal A6 transmits a speech of the user A to the multi-person conference control server 11 (134). The information terminal 6 transmits a speech of a user as a chat message to the multi-person conference control server 11.

The multi-person conference control server 11 receives the speech of the user A. The multi-person conference control server 11 specifies users participating in an electronic conference corresponding to the received speech based on the conference participating user management table 211. Specifically, the multi-person conference control server 11 selects, from the conference participating user management table 211, all records where an identifier of the electronic conference corresponding to the received speech matches a conference ID 212 of the conference participating user management table 211. The multi-person conference control server 11 extracts participating user ID's 213 from all the selected records.

The multi-person conference control server 11 specifies users identified by the extracted participating user ID's 213 as users participating in the electronic conference corresponding to the received speech. In this case, the multi-person conference control server 11 specifies users A to C. The multi-person conference control server 11 specifies users other than the user who has made the speech among the specified users. As the user A has made the speech, the multi-person conference control server 11 specifies the users B and C.

The multi-person conference control server 11 transfers the speech of the user A to information terminals B6 and C6 respectively operated by the specified users B and C (135).

Each of the information terminals B6 and C6 receives the speech of the user A to display it.

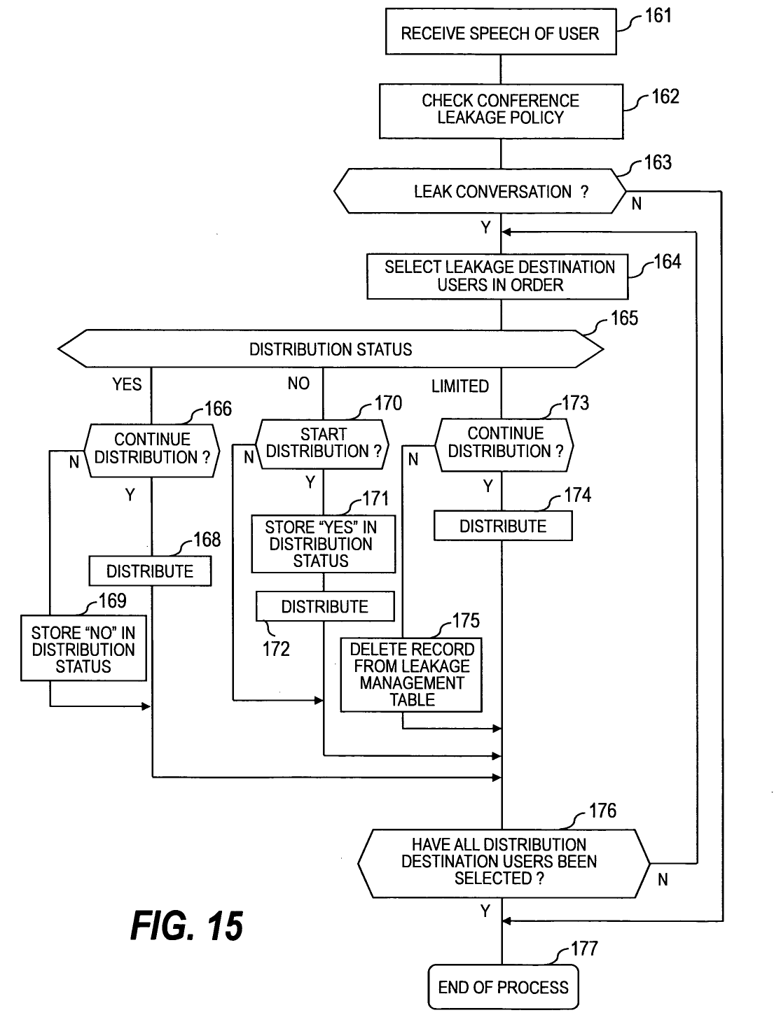

The multi-person conference control server 1 carries out a leakage process. The leakage process will be described below in detail referring to FIG. 15.

In the leakage process, the multi-person conference control server 11 judges who of leakage destination users the speech of the user A is leaked to (136). In this case, the multi-person conference control server 11 judges that the speech of the user A is leaked to the users D and E. The multi-person conference control server 11 distributes the speech of the user A to information terminals D6 and E6 operated by the users D and E (137), respectively.

Each of the information terminals D6 and E6 receives the speech of the user A to display it.

The information terminal B6 transmits a speech of the user B to the multi-person conference control server 11 (138).

The multi-person conference control server 11 receives the speech of the user B. The multi-person conference control server 11 specifies users other than the user who has made the received speech among users participating in an electronic conference corresponding to the received speech. In this case, as the user B has made the speech, the multi-person conference control server 11 specifies the users A and C.

The multi-person conference control server 11 transfers the speech of the user B to the information terminals A6 and C6 operated by the specified users A and C, respectively (139).

Each of the information terminals A6 and C6 receives the speech of the user B to display it.

The multi-person conference control server 1 carries out a leakage process shown in FIG. 15. In the leakage process, the multi-person conference control server 11 judges who of leakage destination users the speech of the user B is leaked to (140). In this case, the multi-person conference control server 11 judges that the speech of the user B is leaked to the users D and E. The multi-person conference control server 11 distributes the speech of the user B to the information terminals D6 and E6 operated by the users D and E, respectively (141).

Each of the information terminals D6 and E6 receives the speech of the user B to display it.

Then, the conversation continues at the electronic conference.

The user E takes an interest in the conversation of the electronic conference to participate in the electronic conference. In this case, the information terminal E6 operated by the user E transmits a conference room entry request to the multi-person conference control server 11 (146).

Upon reception of the conference room entry request, the multi-person conference control server 11 analyzes the received conference room entry request. Accordingly, the multi-person conference control server 11 specifies a conference requested for participation and a user who has requested participation. The multi-person conference control server 11 updates the conference participating user management table 211 shown in FIG. 9.

The multi-person conference control server 11 updates the leakage management table 231. Specifically, the multi-person conference control server 11 selects records where an identifier of the conference identified in the step 146 matches a conference ID 232 of the leakage management table 231. The multi-person conference control server 11 selects, among the selected records, records where an identifier of the user specified in the step 146 matches a leakage target user ID 236 of the leakage management table 231. The multi-person conference control server 11 stores information indicating that the conversation of the electronic conference has not been distributed in a distribution status 235 of each of the selected records. Accordingly, the multi-person conference control server 11 changes the user E from the leakage destination user to the user participating in the conference.

The multi-person conference control server 11 carries out a leakage range deciding process of FIG. 14 at the time of reception of the conference room entry request.

The multi-person conference control server 11 transmits a personal-connection information acquisition request containing the identifier of the user specified in the step 146 to the personal-connection information management server 14 (1136).

The multi-person conference control server 11 obtains personal-connection information containing an identifier of the user F (1137). The multi-person conference control server 11 sets the user F as a leakage destination user. In other words, the multi-person conference control server 11 decides to distribute the conversation of the electronic conference specified in the step 146 to the information terminal F6 operated by the user F. Accordingly, the multi-person conference control server 11 leaks the conversation of the electronic conference to the user F.

The information terminal A6 transmits the speech of the user A to the multi-person conference control server 11 (157)

The multi-person conference control server 11 receives the speech of the user A. The multi-person conference control server 11 specifies users other than the user who has made the received speech among users participating in an electronic conference corresponding to the received speech. In this case, as the user A has made the speech, the multi-person conference control server 11 specifies the users B, C and E.

The multi-person conference control server 11 transfers the speech of the user A to the information terminals B6, C6 and E6 operated by the specified users B, C and E, respectively (158).

Each of the information terminals B6, C6 and E6 receives the speech of the user A to display it.

The multi-person conference control server 11 carries out a leakage process shown in FIG. 15. In the leakage process, the multi-person conference control server 11 judges who of leakage destination users the speech of the user A is leaked to (159). In this case, the multi-person conference control server 11 judges that the speech of the user A is leaked to the users D and F. The multi-person conference control server 11 distributes the speech of the user A to information terminals D6 and F6 operated by the users D and F, respectively (160).

Each of the information terminals D6 and F6 receives the speech of the user A to display it.

Then, the user E tries to exit from the electronic conference. In this case, the information terminal E6 operated by the user E transmits a conference room exit request to the multi-person conference control server 11 (1131).

Upon reception of the conference room exit request, the multi-person conference control server 11 analyzes the received conference room exit request. Accordingly, the multi-person conference control server 11 specifies a conference requested for exit, and a user who has requested exit. In this case, the multi-person conference control server 11 specifies the user E who operates the information terminal E6 of a transmission source of the conference room exit request as a user who has requested exit.

The multi-person conference control server 11 updates the conference participating user management table 211 shown in FIG. 9 based on the specified conference and the specified user.

Specifically, the multi-person conference control server 11 selects, from the conference participating user management table 211, all records where an identifier of the conference specified in the step 1131 matches a conference ID of the conference participating user management table 211. The multi-person conference control server 11 selects records where an identifier of the user specified in the step 1131 matches a participating user ID 213 from the selected records. The multi-person conference control server 11 deletes the selected records from the conference participating user management table 211.

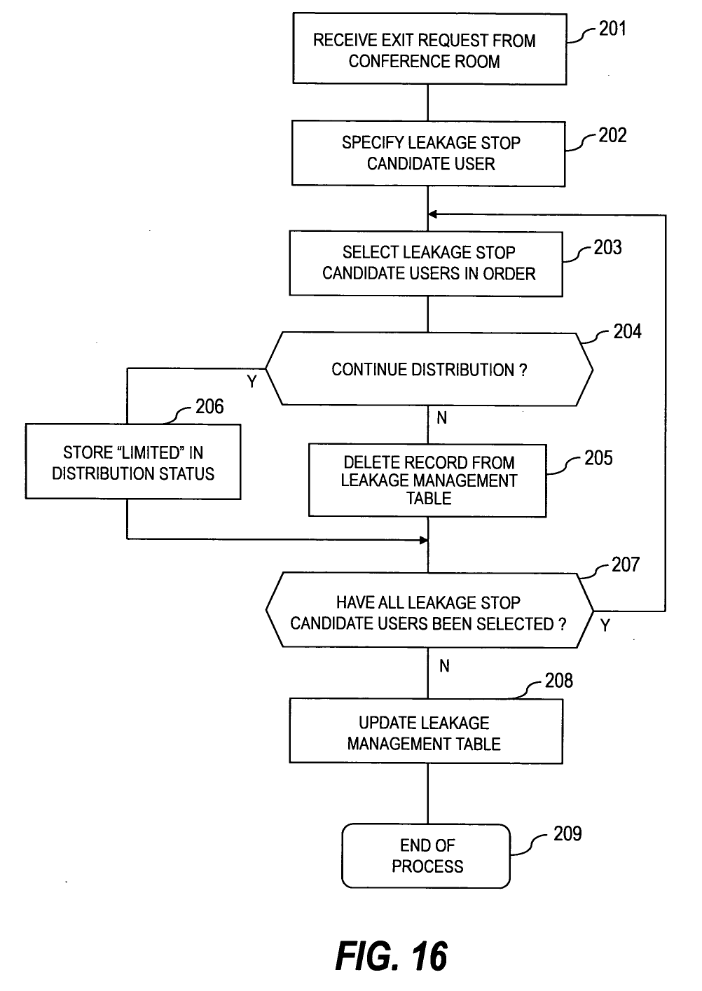

The multi-person conference control server 1 carries out a leakage range deciding process at the time of reception of the conference room exit request. The leakage range deciding process at the time of reception of the conference room exit request will be described below in detail referring to FIG. 16.

In this case, the multi-person conference control server 11 sets the user F as a limited leakage destination user. In other words, the multi-person conference control server 11 distributes a conversation of the electronic conference to the information terminal F6 operated by the user F for a predetermined time after the exit of the user E. Accordingly, the multi-person conference control server 11 leaks the conversation of the electronic conference to the user F for a predetermined time after the exit of the user E.

The multi-person conference control server 11 judges whether a user who has a human relation to the user E specified in the step 1131 participates in the specified conference. In this case, the user C who has a human relation to the user E specified in the step 1131 participates in the conference. Accordingly, the multi-person conference control server 11 updates the leakage management table 231.

Specifically, the multi-person conference control server 11 selects, from the leakage management table 231, records where the identifier of the conference specified in the step 1131 matches a conference ID 232 of the leakage management table 231. The multi-person conference control server 11 selects, among the selected records, records where the identifier of the user specified in the step 1131 matches a leakage target user ID 236 of the leakage management table 231. The multi-person conference control server 11 stores information indicating that the conversation of the electronic conference has been distributed in a record distribution status 235 of each of the selected records.

Thus, the multi-person conference control server 11 changes the user E from the user participating in the electronic conference to the leakage destination user.

The information terminal A6 transmits a speech of the user A to the multi-person conference control server 11 (1132).

The multi-person conference control server 11 receives the speech of the user A. The multi-person conference control server 11 specifies users other than the user who has made the received speech among users participating in an electronic conference corresponding to the received speech. In this case, as the user A has made the speech, the multi-person conference control server 11 specifies the users B and C.

The multi-person conference control server 11 transfers the speech of the user A to the information terminals B6 and C6 operated by the specified users B and C, respectively (1133).

Each of the information terminals B6 and C6 receives the speech of the user A to display it.

The multi-person conference control server 1 carries out a leakage process shown in FIG. 15.

In the leakage process, the multi-person conference control server 11 judges who of leakage destination users the speech of the user A is leaked to (1134). In this case, the multi-person conference control server 11 judges that the speech of the user A is leaked to the users D to F. The multi-person conference control server 11 distributes the speech of the user A to the information terminals D6 to F6 operated by the users D to F, respectively (1135).

Each of the information terminals D6 to F6 receives the speech of the user A to display it.

Then, the electronic conference is similarly continued.

FIG. 14 is a flowchart of a leakage range deciding process at the time of conference room entry request reception of the multi-person conference control server 11 according to the first embodiment of this invention.

Upon reception of a conference room entry request (181), the multi-person conference control server 11 carries out a leakage range deciding process at the reception time of the conference room entry request. When all users participating in the conference room belong to the same group, the conference room entry request is a group created request.

First, the multi-person conference control server 11 analyzes the received conference room entry request. Accordingly, the multi-person conference control server 11 specifies an electronic conference requested for participation and a user who has requested participation. The multi-person conference control server 11 updates the conference participating user management table 211 based on the specified electronic conference and the specified user.

The multi-person conference control server 11 transmits a personal-connection information acquisition request containing an identifier of the specified user to the personal-connection information management server 14. Accordingly, the multi-person conference control server 11 requests acquisition of personal-connection information containing a list of identifiers of all users present within a predetermined distance from the specified user. The personal-connection information management server 14 may request acquisition of personal-connection information containing identifies of users who satisfy conditions other than the distance.

The personal-connection information management server 14 receives the personal-connection information acquisition request. The personal-connection information management server 14 extracts the identifier of the user from the received personal-connection information acquisition request. The personal-connection information management server 14 refers to the personal-connection information table 221 to specify all the users present within the predetermined distance from the user identified by the extracted user identifier.

The personal-connection information management server 14 transmits personal-connection information containing a list of identifiers of all the specified users to the multi-person conference control server 11.

The multi-person conference control server 11 receives the personal-connection information from the personal-connection information management server 14 (182). Then, the multi-person conference control server 11 analyzes the received personal-connection information.

Specifically, the multi-person conference control server 11 extracts user identifiers from the received personal-connection information. The multi-person conference control server 11 refers to the conference participating user management table 211 to specify users not participating in the specified electronic conference among all users identified by the extracted user identifiers. The multi-person conference control server 11 sets the specified users as leakage destination candidate users.

The multi-person conference control server 11 judges whether leakage destination candidate users have successfully been specified (183).

If leakage destination candidate users have not been specified, the multi-person conference control server 11 finishes the leakage range deciding process at the reception time of the conference room entry request.

On the other hand, if leakage destination candidate users have been specified, the multi-person conference control server 11 selects all the specified leakage destination candidate users one by one in order (184).

The multi-person conference control server 11 judges whether to leak a conversation of the specified electronic conference to the selected leakage destination candidate users (185). In other words, the multi-person conference control server 11 judges whether to leak the conversation of the specified electronic conference to the selected leakage destination candidate users.

For example, the multi-person conference control server 11 judges whether to leak the conversation of the specified electronic conference to the selected leakage destination candidate users based on log-in status of the selected leakage destination candidate users or whether the selected leakage destination candidate users wish to obtain a leaked conversation.

If it is judged not to leak the conversation of the electronic conference to the selected leakage destination candidate users, the multi-person conference control server 11 updates the leakage management table 231 (191).

Specifically, the multi-person conference control server 11 adds a new record to the leakage management table 231. The multi-person conference control server 11 stores the identifier of the electronic conference specified in the step 181 in a conference ID 232 of the new record. The multi-person conference control server 11 stores the identifier of the user specified in the step 181 in a participating user ID 233 of the new record. The multi-person conference control server 11 stores identifiers of the selected leakage candidate users in a leakage target user ID 236 of the new record. The multi-person conference control server 11 stores information indicating that the conversion of the electronic conference has not been distributed in a distribution status 235 of the new record.

Thus, the multi-person conference control server 11 updates the leakage management table 231. The multi-person conference control server 11 judges whether all the specified leakage destination candidate users have been selected in the step 184 (190).

If even any one of the specified leakage destination candidate users has not been selected, the multi-person conference control server 11 returns to the step 184 to repeat the process.

On the other hand, if all the specified leakage destination candidates have been selected, the multi-person conference control server 11 finishes the leakage range deciding process at the reception time of the conference room entry request.

If it is judged in the step 185 that the conversation of the electronic conference is leaked to the selected leakage destination candidate users, the multi-person conference control server 11 updates the leakage management table 231 (186).

Specifically, the multi-person conference control server 11 adds a new record to the leakage management table 231. The multi-person conference control server 11 stores the identifier of the electronic conference specified in the step 181 in a conference ID 232 of the new record. The multi-person conference control server 11 stores the identifier of the user specified in the step 181 in a participating user ID 233 of the new record. The multi-person conference control server 11 stores the identifiers of the selected leakage destination candidate users in a leakage target user ID 236 of the new record. The multi-person conference control server 11 stores information indicating that the conversation of the electronic conference has been distributed in a distribution status 235 of the new record.

As described above, the multi-person conference control server 11 updates the leakage management table 231. The multi-person conference control server 11 selects, from the conference information management table 214, records where the identifier of the electronic conference specified in the step 181 matches the conference ID 215 of the conference information management table 214. The multi-person conference control server 11 extracts a leakage flag 219 from the selected records. The multi-person conference control server 11 checks a policy on the conversation leakage of the electronic conference specified in the step 181 based on the extracted leakage flag 219 (187).

In other words, the multi-person conference control server 11 judges, based on the extracted leakage flag 219, whether to leak the conversation of the electronic conference specified in the step 181 (188).

If the conversation of the electronic conference is not leaked, the multi-person conference control server 11 proceeds to a step 190. The multi-person conference control server 11 judges whether all the specified leakage destination candidate users have been selected in the step 184 (190).

If even any one of the specified leakage destination candidate users has not been selected, the multi-person conference control server 11 returns to the step 184 to repeat the process.

If all the specified leakage destination candidate users have been selected, the multi-person conference control server 11 finishes the leakage range deciding process of the conference room entry request.

On the other hand, if the conversation of the electronic conference is leaked, the multi-person conference control server 11 sets the selected leakage destination candidate users as leakage destination users of the conversation of the electronic conference specified in the step 181. In other words, when the conversation of the electronic conference is leaked, the multi-person conference control server 11 decides to distribute the conversation of the electronic conference specified in the step 181 to the information terminals 6 operated by the selected leakage destination candidate users (189). Accordingly, the multi-person conference control server 11 distributes, after the distribution has been decided, the conversation of the electronic conference to the information terminals 6 operated by the selected leakage destination candidate users.

The multi-person conference control server 11 may distribute the conversation of the electronic conference of a certain period before the distribution decision to the information terminals 6 operated by the selected leakage destination candidate users. Accordingly, the leakage destination candidate users can grasp contents of conversations made so far.

The multi-person conference control server 11 judges whether all the specified leakage destination candidate users have been selected in the step 184 (190).

If even any one of the specified leakage destination candidate users has not been selected, the multi-person conference control server 11 returns to the step 184 to repeat the process.

On the other hand, if all the specified leakage destination candidate users have been selected, the multi-person conference control server 11 finishes the leakage range deciding process at the reception time of the conference room entry request.

FIG. 15 is a flowchart of a leakage process of the multi-person conference control server 11 according to the first embodiment of this invention.

Upon reception of a speech of a user (161), the multi-person conference control server 11 carries out the leakage process.

First, the multi-person conference control server 11 transfers the received speech to information terminals operated by users participating in an electronic conference corresponding to the received speech.

The multi-person conference control server 11 selects, from the conference information management table 214, records where an identifier of the electronic conference corresponding to the received speech matches a conference ID 215 of the conference information management table 214. The multi-person conference control server 11 extracts a leakage flag 219 from the selected records. The multi-person conference control server 11 checks a policy on conversation leakage of the electronic conference corresponding to the received speech based on the extracted leakage flag 219 (162).

The multi-person conference control server 11 can quickly deal with a change of the policy as it checks the policy for each speech.

In other words, the multi-person conference control server 11 judges whether to leak the received speech based on the extracted leakage flag 219 (163).

If a conversation of the electronic conference is not leaked, the multi-person conference control server 11 leaks no conversation to users other than the users participating in the electronic conference. Thus, the multi-person conference control server 11 finishes the leakage process.

On the other hand, if the conversation of the electronic conference is leaked, the multi-person conference control server 11 selects all leakage destination users of the electronic conference corresponding to the received speech one by one in order (164).

Specifically, the multi-person conference control server 11 selects, from the leakage management table 231, all records where the identifier of the electronic conference corresponding to the received speed matches a conference ID 232 of the leakage management table 231. The multi-person conference control server 11 selects all the selected records one by one in order.

The multi-person conference control server 11 extracts a distribution status 235 from the selected records. The multi-person conference control server 11 carries out a process corresponding to the extracted distribution status 235 (165).

If the extracted distribution status 235 indicates that the conversation of the electronic conference has been distributed, the multi-person conference control server 11 judges whether to continue distribution of the conversation of the electronic conference to the information terminals 6 operated by the selected leakage destination users (166).

For example, based on log-in status of the selected leakage destination candidate users or whether the selected leakage destination candidate users wish to obtain a leaked conversation, the multi-person conference control server 11 judges whether to continue the distribution of the conversation of the electronic conference to the information terminals 6 operated by the selected leakage destination users.

If the distribution is not continued, the multi-person conference control server 11 stores information indicating that the conversation of the electronic conference has not been distributed in the distribution status 235 of the selected record (169). Then, the multi-person conference control server 11 proceeds to a step 176.

On the other hand, if the distribution is continued, the multi-person conference control server 11 distributes the speech of the user received in the step 161 to the information terminals 6 operated by the selected leakage destination candidate users (168).

The multi-person conference control server 11 judges whether all the leakage destination users have been selected in the step 164 (176).

If any one of the leakage destination users has not been selected, the multi-person conference control server 11 returns to the step 164 to repeat the process.

On the other hand, if all the specified leakage destination users have been selected, the multi-person conference control server 11 finishes the leakage process.

If the extracted distribution status 235 indicates that the conversation of the electronic conference has not been distributed, the multi-person conference control server 11 judges whether to start distribution of the conversation of the electronic conference to the information terminals 6 operated by the selected leakage destination users (170).

For example, based on log-in status of the selected leakage destination candidate users or whether the selected leakage destination candidate users wish to obtain the leaked conversation, the multi-person conference control server 11 judges whether to start distribution of the conversation of the electronic conference to the information terminals 6 operated by the selected leakage destination users.

If the distribution is started, the multi-person conference control server 11 proceeds to a step 176.

On the other hand, if the distribution is started, the multi-person conference control server 11 stores information indicating that the conversation of the electronic conference has been distributed in the distribution status 235 of the selected record (171).

The multi-person conference control server 11 distributes the speech of the user received in the step 161 to the information terminals 6 operated by the selected leakage destination candidate users (172).

The multi-person conference control server 11 judges whether all the leakage destination users have been selected in the step 164 (176).

If even one of the leakage destination users has not been selected, the multi-person conference control server 11 returns to the step 164 to repeat the process.

On the other hand, if all the specified leakage destination users have been selected, the multi-person conference control server 11 finishes the leakage process.

If the extracted distribution status 235 indicates that the conversation of the electronic conference has been limitedly distributed, the multi-person conference control server 11 judges whether or not to continue the distribution of the conversation of the electronic conference to the information terminal 6 operated by the selected leakage destination user (173).

For example, based on a log-in status of the selected leakage destination candidate user, whether the selected leakage destination user wishes to obtain a conversation leakage, or an elapsed time from a time stamp 234 of the selected record, the multi-person conference control server 11 judges whether or not to continue the distribution of the conversation of the electronic conference to the information terminal 6 operated by the selected leakage destination user.

Specifically, if the elapsed time from the time stamp 234 of the selected record is a predetermined time or less, the multi-person conference control server 11 judges that the distribution of the conversation of the electronic conference to the information terminal 6 operated by the selected leakage destination user is continued. On the other hand, if the elapsed time from the time stamp 234 of the selected record is more than the predetermined time, the multi-person conference control server 11 judges that the distribution of the conversation of the electronic conference to the information terminal 6 operated by the selected leakage destination user is not continued.

If the distribution is not continued, the multi-person conference control server 11 deletes the selected record from the leakage management table 231 (175). It is because the user identified by the participating user ID 233 of the selected record has exited from the electronic conference. Then, the multi-person conference control server 11 proceeds to a step 176.

On the other hand, if the distribution is continued, the multi-person conference control server 11 distributes the speech of the user received in the step 161 to the information terminal 6 operated by the selected leakage destination candidate user (174).

Next, the multi-person conference control server 11 judges whether all the leakage destination users have been selected in the step 164 (176).

If any one of the leakage destination users has not been selected, the multi-person conference control server 11 returns to the step 164 to repeat the process.

On the other hand, if all the specified leakage destination users have been selected, the multi-person conference control server 11 finishes the leakage process.

FIG. 16 is a flowchart of a leakage range deciding process of the multi-person conference control server at the reception time of a conference room exit request according to the first embodiment of this invention.

Upon reception of a conference room exit request (201), the multi-person conference control server 11 carries out a leakage range deciding process at the reception time of the conference room exit request.

First, the multi-person conference control server 11 analyzes the received conference room exit request. Accordingly, the multi-person conference control server 11 specifies a conference requested for exit and a user who has made the exit request. The multi-person conference control server 11 updates the conference participating user management table 211 shown in FIG. 9 based on the specified conference and the specified user.

The multi-person conference control server 11 selects, from the leakage management table 231, records where an identifier of the specified conference matches a conference ID 232 of the leakage management table 231. The multi-person conference control server 11 selects, from the selected records, records where an identifier of the specified user matches a participating user ID 233. The multi-person conference control server 11 specifies users identified by leakage target user ID's 236 of the selected record as leakage stop candidate users (202).

The multi-person conference control server 11 selects all the specified leakage stop candidate users one by one in order (203). Specifically, the multi-person conference control server 11 selects all the selected records one by one in order.

Based on a leakage stop policy or the like, the multi-person conference control server 11 judges whether or not to continue distribution of a conversation of the electronic conference to the selected leakage candidate users (204).

If the distribution is not continued, the multi-person conference control server 11 deletes the selected record from the leakage management table 231 (205). Then, the multi-person conference control server 11 proceeds to a step 207.

On the other hand, if the distribution is continued, the multi-person conference control server 11 stores information indicating that the conversation of the electronic conference has been limitedly distributed in a distribution status 235 of the selected record (206). The multi-person conference control server 11 stores current time in a time stamp 234 of the selected record.

The multi-person conference control server 11 judges whether all the specified leakage stop candidate users have been selected in the step 202 (207).

If any one of the leakage stop candidate users has not been selected, the multi-person conference control server 11 returns to the step 203 to repeat the process.

On the other hand, if all the specified leakage stop candidate users have been selected, the multi-person conference control server 11 selects, from the leakage management table 231, records where the identifier of the conference specified in the step 201 matches the conference ID 232 of the leakage management table 231. The multi-person conference control server 11 selects, from the selected records, records where the identifier of the user specified in the step 201 matches the leakage target user ID 236 of the leakage management table 231. Upon selection of the records, the multi-person conference control server 11 stores information indicating that the conversation of the electronic conference has been distributed in the distribution status 235 of each of the selected records (208).

Accordingly, the multi-person conference control server 11 updates the user specified in the step 201 from the user participating in the electronic conference to the leakage destination user. Then, the multi-person conference control server 11 finishes the leakage range deciding process at the reception time of the conference room exit request.

According to the embodiment, the multi-person conference control server 11 can leak contents of the conversation of the electronic conference to a user who has a human relation to at least one of the users participating in the electronic conference. Thus, as users not participating in the electronic conference can know the contents of the electronic conference, a conversation broadens.

### Second Embodiment

According to the first embodiment, the multi-person conference control server 11 leaks the conversation of the electronic conference without considering a status of the leakage destination user. According to a second embodiment, however, a multi-person conference control server 11 judges whether or not to leak a conversation of an electronic conference by considering a status of a leakage destination user.

A configuration of a communication system of the second embodiment is similar to that of the communication system of the first embodiment shown in FIG. 4 except for the fact that the multi-person conference control server 11 stores a presence information table 251. Components similar to those of the first embodiment are denoted by similar reference numerals, and description thereof will be omitted. The presence information table 251 indicates a status of a user who operates an information terminal 6.

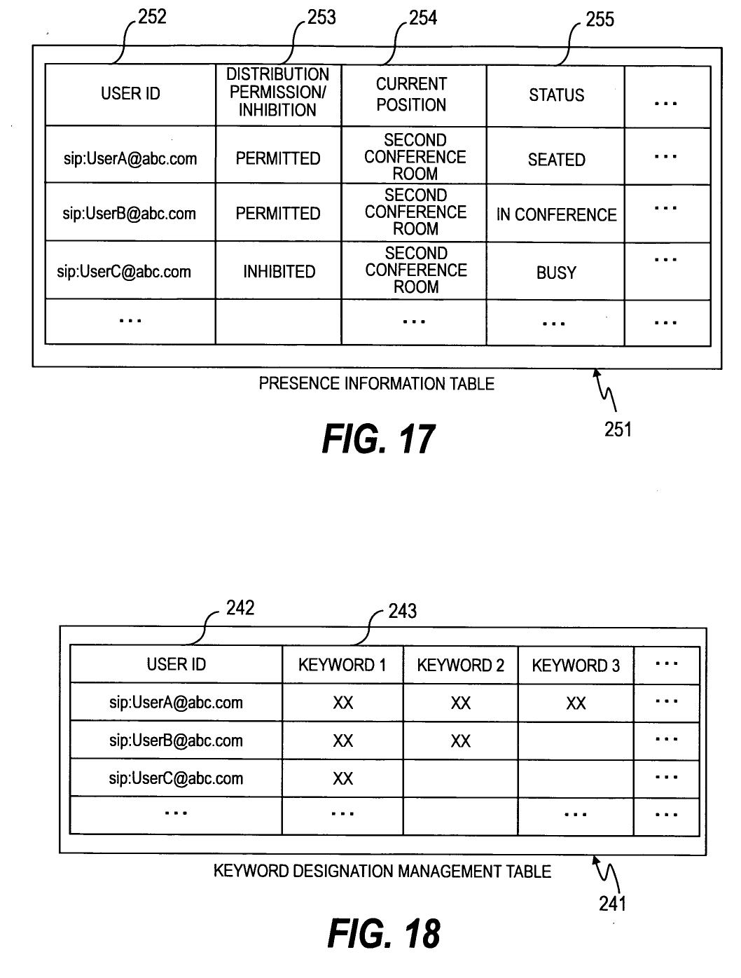

FIG. 17 illustrates a configuration of the presence information table 251 stored by the multi-person conference control server 11 according to the second embodiment of this invention.

The presence information table 251 includes a user ID 252, a distribution permission/inhibition flag 253, a current position 254, and a status 255.

The user ID 252 is a unique identifier of a user who operates an information terminal 6. The distribution permission/inhibition flag 253 indicates whether the user identified by the user ID 252 of a record wishes to obtain a leaked conversation of an electronic conference. The multi-person conference control server 11 updates the distribution permission/inhibition flag 253 according to a request from the information terminal 6.

The current position 254 is a position where the user identified by the user ID 252 of the record is currently present. The status 255 indicates a status of the user identified by the user ID 252 of the record. The multi-person conference control server 11 obtains information from the information terminal 6 or a sensor, and updates the current position 254 and the status 255 according to an obtained status.

The presence information table 251 may be stored not by the multi-person conference control server 11 but by a presence server. The presence server is a computer which includes a CPU, a memory and an interface, and monitors a change in status of each user. The presence server notifies a monitored status change to the multi-person conference control server 11.

According to the embodiment, the multi-person conference control server 11 refers to the presence information table 251 to make judgements of the steps 166, 170 and 173 of the leakage process shown in FIG. 15. The multi-person conference control server 11 refers to the presence information table 251 to make judgement of the step 185 of the leakage range deciding process at the reception time of the conference room entry request shown in FIG. 14.

The step 185 of the leakage range deciding process at the reception time of the conference room entry request shown in FIG. 14 will be described below.

The multi-person conference control server 11 selects, from the presence information table 251, records where the identifier of the leakage destination candidate user selected in the step 184 matches the user ID 252 of the presence information table 251. The multi-person conference control server 11 extracts a distribution permission/inhibition flag 253, a current position 254, and a status 255 from each of the selected records.

Based on at least one of the distribution permission/inhibition flag 253, the current position 254, and the status 255 which have been extracted, the multi-person conference control server 11 judges whether or not to leak the conversation of the electronic conference specified in the step 184.

For example, if the extracted distribution permission/inhibition flag 253 indicates that a user wishes to obtain a conversation leakage of the electronic conversation, the multi-person conference control server 11 judges that the conversation of the electronic conference specified in the step 184 is leaked.

On the other hand, if the extracted distribution permission/inhibition flag 253 indicates that a user does not wish to obtain any conversation leakage of the electronic conference, the multi-person conference control server 11 judges that the conversation of the electronic conversation specified in the step 184 is not leaked.

If the extracted status 255 indicates an in-conference or busy status, the multi-person conference control server 11 judges that the conversation of the electronic conference specified in the step 184 is not leaked.

On the other hand, if the extracted status 255 indicates a seated status, the multi-person conference control server 11 judges that the conversation of the electronic conference specified in the step 184 is leaked.

As described above, according to the second embodiment, the multi-person conference control server 11 can judge whether or not to leak the conversation of the electronic conference by considering the status of the leakage destination user.

### Third Embodiment

According to the first embodiment, the multi-person conference control server 11 leaks the conversation of the electronic conference without considering contents of the conversation of the electronic conference. According to a third embodiment, however, a multi-person conference control server 11 judges whether or not to leak a conversation of an electronic conference by considering contents of the conversation of the electronic conversation.

A configuration of a communication system of the third embodiment is similar to that of the communication system of the first embodiment shown in FIG. 4 except for the fact that the multi-person conference control server 11 stores a keyword designation management table 241. Components similar to those of the first embodiment are denoted by similar reference numerals, and description thereof will be omitted. The keyword designation management table 241 indicates contents of a conversation whose distribution a user wishes.

FIG. 18 illustrates a configuration of the keyword designation management table 241 stored by the multi-person conference control server 11 according to the third embodiment of this invention.

The keyword designation management table 241 includes a user ID 242 and a keyword 243.

The user ID 242 is a unique identifier of a user who operates an information terminal 6. The keyword 243 is a word indicating contents of a conference whose distribution the user identified by the user ID 242 of a record wishes. The multi-person conference control server 11 updates the keyword 243 according to a request from the information terminal 6.

The multi-person conference control server 11 may analyze an electronic file stored in the information terminal 6 and access history of the information terminal 6, and automatically update the keyword 243 based on a result of the analysis.

The analysis of the electronic file and the access history may be carried out by the information terminal 6. In this case, the multi-person conference control server 11 receives an analysis result of the information terminal 6, and updates the keyword 243 based on the received analysis result.

According to the embodiment, the multi-person conference control server 11 refers to the keyword designation management table 241 to make judgements of the steps 166, 170 and 173 of the leakage process shown in FIG. 15. The multi-person conference control server 11 refers to the keyword designation management table 241 to make judgement of the step 185 of the leakage range deciding process at the reception time of the conference room entry request shown in FIG. 14.

The step 185 of the leakage range deciding process at the reception time of the conference room entry request shown in FIG. 14 will be described below.

The multi-person conference control server 11 analyzes contents of the conversation of the electronic conference specified in the step 184. The multi-person conference control server 11 selects, from the keyword designation management table 241, records where the identifier of the leakage destination candidate user selected in the step 184 matches the user ID 242 of the keyword designation management table 241. The multi-person conference control server 11 extracts a keyword 243 from each of the selected records.

The multi-person conference control server 11 judges whether an analysis result of the contents of the conversation matches the extracted keyword 243. The matching between the analysis result and the keyword 243 may be either partial or total matching.

If the analysis result matches the keyword 243, the multi-person conference control server 11 judges that the conversation of the electronic conference specified in the step 184 is leaked.

On the other hand, if the analysis result does not match the keyword 243, the multi-person conference control server 11 judges that the conversation of the electronic conference specified in the step 184 is not leaked.

The multi-person conference control server 11 may use a document in place of the keyword 243 to make judgement of each step. In this case, the multi-person conference control server 11 calculates a similarity between the conversation of the electronic conference and the document, and judges whether or not to leak the conversation of the electronic conference based on the calculated similarity.

Thus, according to the third embodiment, the multi-person conference control server 11 can judge whether or not to leak the conversation of the electronic conference by considering the contents of the conversation of the electronic conference.

### Fourth Embodiment

According to the first embodiment, the multi-person conference control server 11 leaks the conversation of the electronic conference without considering a type of a human relation. According to a fourth embodiment, however, a multi-person conference control server 11 judges whether or not to leak a conversation of an electronic conference by considering a type of a human relation.

A configuration of a communication system of the fourth embodiment is similar to that of the communication system of the first embodiment shown in FIG. 4. Components similar to those of the first embodiment are denoted by similar reference numerals, and description thereof will be omitted.

According to the embodiment, a personal-connection information management server 14 transmits personal-connection information containing not only a list of user identifiers but also a type of relation 224 of a personal-connection information table 221, a related document 225, and a keyword 226 to the multi-person conference control server 11.

The multi-person conference control server 11 extracts the type of relation 224, the related document 225, and the keyword 226 from the received personal-connection information. The multi-person conference control server 11 refers to at least one of the type of relation 224, the related document 225, and the keyword 226 which have been extracted to make judgements of the steps 166, 170 and 173 of the leakage process shown in FIG. 15. The multi-person conference control server 11 refers to at least one of the type of relation 224, the related document 225, and the keyword 226 which have been extracted to make judgement of the step 185 of the leakage range deciding process at the reception time of the conference room entry request shown in FIG. 14.

Thus, according to the fourth embodiment, the multi-person conference control server 11 can judge whether or not to leak the conversation of the electronic conference by considering a type of a human relation.

### Fifth Embodiment

According to the first embodiment, the same policy on the conversion leakage applies to all the electronic conferences. According to a fifth embodiment, however, a policy on conversation leakage (leakage policy) varies from one electronic conference to another.

A configuration of a communication system of the fifth embodiment is similar to that of the communication system of the first embodiment shown in FIG. 4 except for the fact that a multi-person conference control server 11 stores a leakage policy management table 271. Components similar to those of the first embodiment are denoted by similar reference numerals, and description thereof will be omitted. The leakage policy management table 271 indicates a leakage policy for each electronic conference.

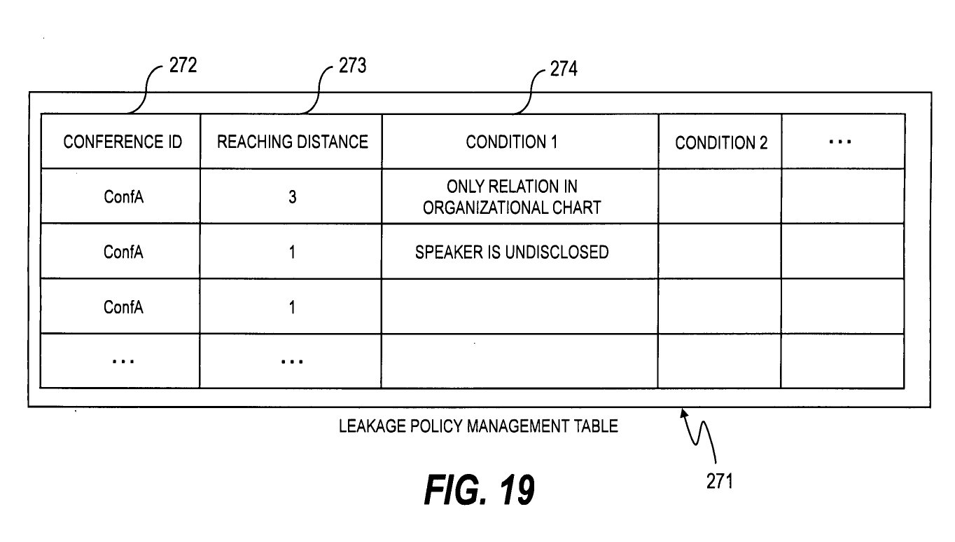

FIG. 19 illustrates a configuration of the leakage policy management table 271 stored by the multi-person conference control server 11 according to the fifth embodiment of this invention.

The leakage policy management table 271 includes a conference ID 272, a reaching distance 273, and a condition 274.

The conference ID 272 is a unique identifier of an electronic conference managed by the multi-person conference control server 11. The reaching distance 273 is a maximum value of a distance between a user participating in the electronic conference identified by the conference ID 172 and a user who can be a leakage destination.

The condition 274 is a condition for leaking a conversation made at the electronic conference identified by the conference ID 272. Any condition may be used for the condition 274. For example, the condition 274 may indicate leakage of a conversation only to a user having a relation of an organizational chart to the user participating in the electronic conference. The condition 274 may indicate leakage of a conversation carried out while a speaker of the electronic conference is undisclosed.

According to the embodiment, the multi-person conference control server 11 refers to the leakage policy management table 271 to make judgements of the steps 166, 170 and 173 of the leakage process shown in FIG. 15. The multi-person conference control server 11 refers to the leakage policy management table 271 to make judgement of the step 185 of the leakage range deciding process at the reception time of the conference room entry request shown in FIG. 14.

The step 185 of the leakage range deciding process at the reception time of the conference room entry request shown in FIG. 14 will be described below.

The multi-person conference control server 11 selects, from the leakage policy management table 271, records where the identifier of the electronic conference specified in the step 184 matches the conference ID 272 of the leakage policy management table 271. The multi-person conference control server 11 extracts a reaching distance 273 and a condition 274 from each of the selected records. The multi-person conference control server 11 refers to at least one of the reaching distance 273 and the condition 274 which have been extracted to judge whether or not to leak a conversation of the electronic conference specified in the step 184.

Thus, according to the fifth embodiment, a leakage policy can be set for each electronic conference.

### Sixth Embodiment

According to the first embodiment, the personal-connection information management server 14 manages all pieces of personal-connection information. However, batch-management of the pieces of personal-connection information by the personal-connection information management server 14 generates greater psychological resistance on user's part. Thus, according to a sixth embodiment, an information terminal 6 operated by a user manages private personal-connection information.

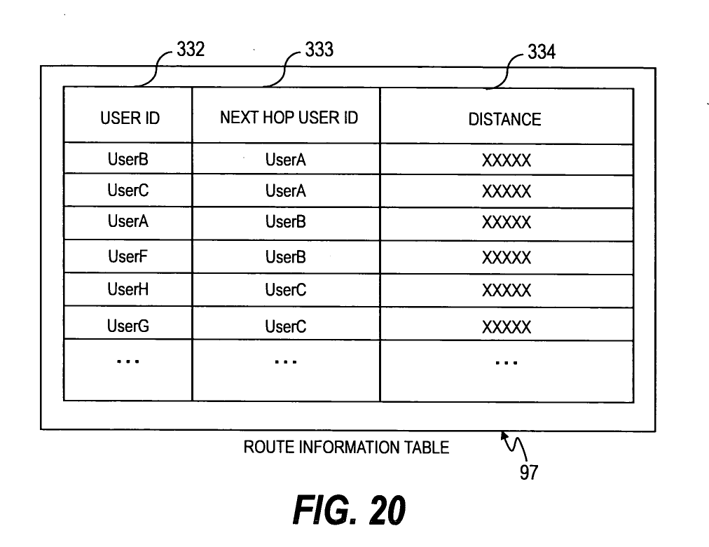

A configuration of a communication system of the sixth embodiment is similar to that of the communication system of the first embodiment shown in FIG. 4 except for the fact that the information terminal 6 stores a route information table 97. Components similar to those of the first embodiment are denoted by similar reference numerals, and description thereof will be omitted. The route information table 97 manages a distance between users. The route information table 97 will be described below in detail referring to FIG. 20.

In the communication system of the sixth embodiment, a mediation route message transmitted by a distance vector type node-by-node such as a RIP of an IP network is used between the information terminals 6. A node of the IP network corresponds to the user in the communication system of the embodiment. A link between nodes corresponds to a relation between the users who have a direct relation

FIG. 20 illustrates a configuration of the route information table 97 stored in the information terminal 6 according to the sixth embodiment of this invention.

The route information table 97 includes a user ID 332, a next hop user ID 333, and a distance 334.

The user ID 332 is a unique identifier of a user who operates an information terminal 6. The next hop user ID 333 is a unique identifier of a user passed first to reach the user identified by the user ID 332 of a certain record from a user who operates the information terminal 6 which stores the route information table 97.

The distance 334 indicates a distance between the user who operates the information terminal 6 which stores the route information table 97 and the user identified by the user ID 332 of the record.

The route information table 97 is used for managing a distance between the user who operates the information terminal 6 which stores the route information table 97 and the other user, but not a human relation to the other user. Thus, according to the embodiment, private information of each user is not leaked.

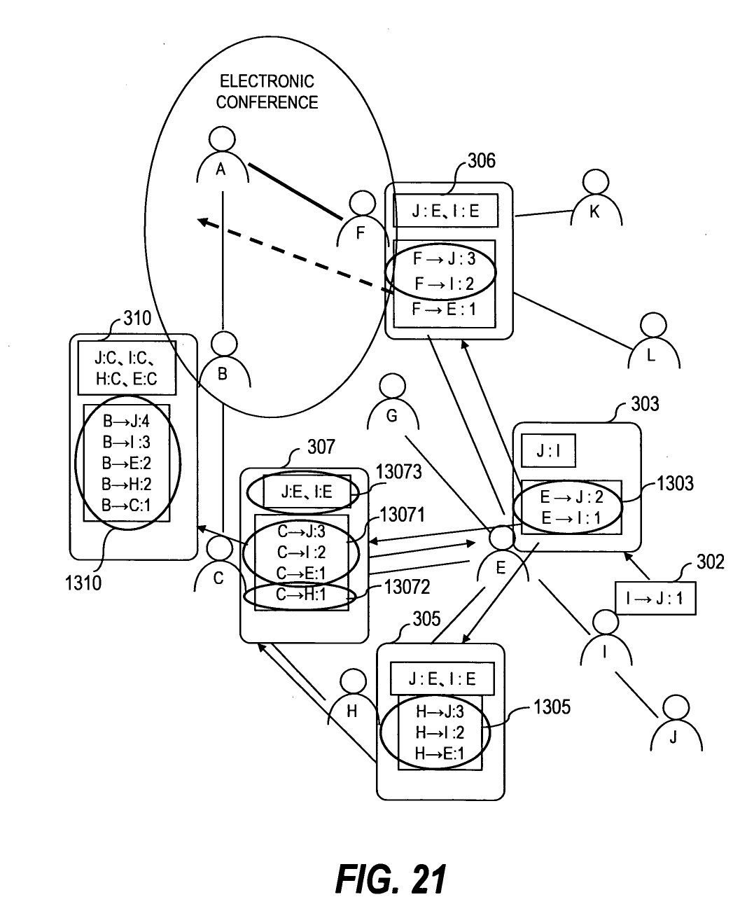

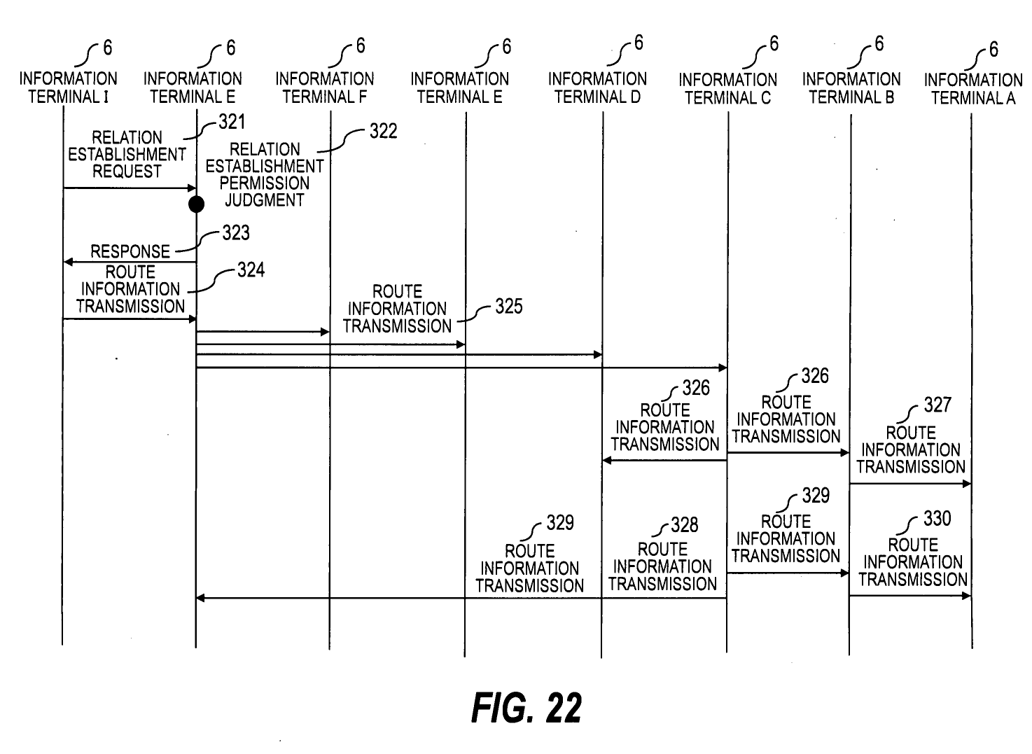

FIG. 21 illustrates a process of the communication system according to the sixth embodiment of this invention. FIG. 22 is a sequential diagram of the process of the communication system according to the sixth embodiment of this invention.

A case where a user I participates as a node of a network will be described.

In this case, an information terminal 16 operated by the user I analyzes information stored in the information terminal 16 to specify a user having a direct relation to the user I. In this case, the information terminal 16 specifies a user E as a user having a direct relation to the user I. Then, the information terminal 16 transmits a relation establishment request to an information terminal E6 operated by the specified user E (321). The relation establishment request is a request of establishing a relation between users.

The information terminal E6 receives the relation establishment request from the information terminal 16. Then, the information terminal E6 displays contents of the received relation establishment request. Accordingly, the information terminal E6 causes the user E to judge whether to permit establishment of a human relation between the user E and the user I (322).

It is presumed that the user E permits establishment of a human relation. The information terminal E6 transmits a response to the received relation establishment request to the information terminal 16 (323).

The information terminal 16 receives the response from the information terminal E6. The information terminal 16 analyzes a private relation information table 89 stored in the information terminal 16. The information terminal 16 transmits route information 302 indicating a user having a direct relation to the user I to the information terminal E6 (324). The route information 302 indicates that a user J has a direct relation to the user I.

The information terminal E6 receives the route information 302. The information terminal E6 analyzes the received route information 302 and the private relation information table 89 stored in the information terminal E6. Accordingly, the information terminal E6 generates route information 303. The route information 303 indicates that the user I is first to be passed in a route from the user E to the user J. The route information 303 indicates that a distance is “2” between the users E and J. The route information 303 indicates that a distance is “1” between the users E and I. The information terminal E6 stores the generated route information 303 in the route information table 97 stored in the information terminal E6.

The information terminal E6 specifies an information terminal 6 operated by a user who has a direct relation to the user E. In this case, the information terminal E6 specifies information terminals C6, F6, G6, and H6 operated by users C, F, G, and H, respectively. The information terminal E6 extracts route information 1303 regarding the user E from the generated route information 303. The information terminal E6 transmits the extracted route information 1303 to the specified information terminals C6, F6, G6 and H6 (325).

The information terminal C6 receives the route information 1303. The information terminal C6 analyzes the received route information 1303 and the private relation information table 89 stored in the information terminal C6. Accordingly, the information terminal C6 generates route information 307. The information terminal C6 stores the generated route information 307 in the route information table 97 stored in the information terminal C6.

Similarly, the information terminal F6 receives the route information 1303. The information terminal F6 analyzes the received route information 1303 and the private relation information table 89 stored in the information terminal F6. Accordingly, the information terminal F6 generates route information 306. The information terminal F6 stores the route information 306 in the route information table 97 stored in the information terminal F6.

Similarly, the information terminal G6 receives the route information 1303. The information terminal G6 analyzes the received route information 1303 and the private relation information table 89 stored in the information terminal G6. Accordingly, the information terminal G6 generates route information. The information terminal G6 stores the generated route information in the route information table 97 stored in the information terminal G6.

Similarly, the information terminal H6 receives the route information 1303. The information terminal H6 analyzes the received route information 1303 and the private relation information table 89 stored in the information terminal H6. Accordingly, the information terminal H6 generates route information 305. The information terminal H6 stores the generated route information 305 in the route information table 97 stored in the information terminal H6.

The information terminal C6 specifies an information terminal 6 operated by a user who has a direct relation to the user C. In this case, the information terminal C6 specifies information terminals B6 and H6 operated by users B and H, respectively. The information terminal C6 extracts route information 13071 from the generated route information 307. The information terminal C6 transmits the extracted route information 13701 to the specified information terminals B6 and H6 (326).

The information terminal B6 receives the route information 13071. The information terminal B6 analyzes the received route information 13071 and the private relation information table 89 stored in the information terminal B6. Accordingly, the information terminal B6 generates route information 310. The information terminal B6 stores the generated route information 310 in the route information table 97 stored in the information terminal B6.

The information terminal B6 specifies an information terminal 6 operated by a user who has a direct relation to the user B. In this case, the information terminal B6 specifies an information terminals A6 operated by the user A. The information terminal B6 extracts route information 1310 from the generated route information 310. The information terminal B6 transmits the extracted route information 1310 to the specified information terminal A6 (327).

The information terminal A6 receives the route information 1310. The information terminal A6 analyzes the received route information 1310 and the private relation information table 89 stored in the information terminal A6. Accordingly, the information terminal A6 generates route information. The information terminal A6 stores the generated route information in the route information table 97 stored in the information terminal A6.

Thus, upon reception of route information from the other information terminal 6, the information terminal 6 generates route information regarding the information terminal 6 based on the received route information. The information terminal 6 transmits a part or all parts of the calculated route information to the information terminal 6 operated by the user who has a direction relation to the user who operates the information terminal 6. The plurality of information terminals 6 repeat this process to propagate the route information.

The information terminal H6 receives the route information 1303 from the information terminal E6 in the step 325. The information terminal h6 analyzes the received route information 1303 and the private relation information table 89 stored in the information terminal H6. Accordingly, the information terminal H6 generates route information 305. The information terminal H6 stores the generated route information 305 in the route information table 97 stored in the information terminal H6.

The information terminal H6 specifies an information terminal 6 operated by a user who has a direct relation to the user H. In this case, the information terminal H6 specifies an information terminal C6 operated by the user C. The information terminal H6 extracts route information 1305 from the generated route information 305. The information terminal H6 transmits the extracted route information 1305 to the specified information terminal C6 (328).

The information terminal C6 receives the route information 1305. The information terminal C6 analyzes the received route information 1305 and the private relation information table 89 stored in the information terminal C6. Accordingly, the information terminal C6 generates route information. The information terminal C6 stores the generated route information in the route information table 97 stored in the information terminal C6. In this case, if the generated route information overlaps the route information stored beforehand in the route information table 97, only the route information of a shorter distance is stored in the route information table 97.

For example, it is presumed that the information terminal C6 receives the route information 1305 from the information terminal H6 after transmission of the route information 13071 to the information terminals B6 and H6 in the step 326. In this case, when the information terminal C6 receives the route information 1305, the route information 13071 and the route information 13073 have been stored in the route information table 97 of the information terminal C6.

The information terminal C6 analyzes the received route information 1305 to grasp that a distance is “3” between the users H and J. The information terminal C6 adds a distance “1” between the users C and H to the distance “3′ between the users H and J to calculate a distance “4” between the users C and J. Thus, the information terminal C6 generates route information indicating that the distance is “4” between the users C and J.

The route information 307 indicating that a distance is “3” between the users C and J has been stored in the route information table 97 of the information terminal C6. The information terminal C6 employs route information of a shorter distance. In this case, the information terminal C6 employs not the generated route information but the route information 307 stored in the route information table 97. Thus, the information terminal C6 does not store the generated route information in the route information table 97.

The information terminal C6 carries out a similar process for distances between the users C and I and between the users C and E. The information terminal C6 analyzes the received route information 305 to generate route information 13072 indicating that a distance is “1” between the users C and H. The information terminal C6 stores the generated route information 13072 in the route information table 97 stored in the information terminal C6.

As the route information table 97 has been updated, the information terminal C6 specifies an information terminal 6 operated by a user who has a direct relation to the user C. In this case, the information terminal C6 specifies information terminals B6 and E6 operated by users B and E, respectively. The information terminal C6 transmits the route information 13072 to the specified information terminals B6 and E6 (329).

The information terminal E6 receives the route information 307. The information terminal E6 analyzes the received route information 13072 and the private relation information table 89 stored in the information terminal E6. Accordingly, the information terminal E6 generates route information. However, the generated route information has been stored beforehand in the route information table 97. Alternatively, a distance indicated by the generated route information is longer than that indicated by the route information stored beforehand in the router information table 97. Thus, the information terminal E6 does not update the route information table 97. When the route information table 97 is not updated, the information terminal E6 transmits no route information to the other information terminal 6.

The information terminal B6 receives the route information 13072. The information terminal B6 analyzes the received route information 13072 and the private relation information table 89 stored in the information terminal B6. Accordingly, the information terminal B6 generates route information. The information terminal B6 stores the generated route information in the route information table 97 stored in the information terminal B6.

The information terminal B6 specifies an information terminal 6 operated by a user who has a direct relation to the user B. In this case, the information terminal B6 specifies an information terminal A6 operated by the user A6. The information terminal B6 transmits the generated route information to the specified information terminal A6 (330).

The information terminal A6 receives the route information. The information terminal A6 analyzes the received route information and the private relation information table 89 stored in the information terminal A6. Accordingly, the information terminal A6 generates route information. The information terminal A6 stores the generated route information in the route information table 97 stored in the information terminal A6.

Thus, the information terminal 6 updates the route information regarding the information terminal 6 based on the received route information. The information terminal 6 transmits the updated route information to the other information terminal 6. All the information terminals 6 repeat this process. When none of the information terminals 6 updates the route information anymore, new route information has been completed.

### Seventh Embodiment

According to the first embodiment, the multi-person conference control server 11 generates conversation leakage. According to the seventh embodiment, however, an information terminal 6 generates conversation leakage.

A configuration of a communication system of the seventh embodiment is similar to that of the communication system of the sixth embodiment shown in FIG. 4. Components similar to those of the sixth embodiment are denoted by similar reference numerals, and description thereof will be omitted.

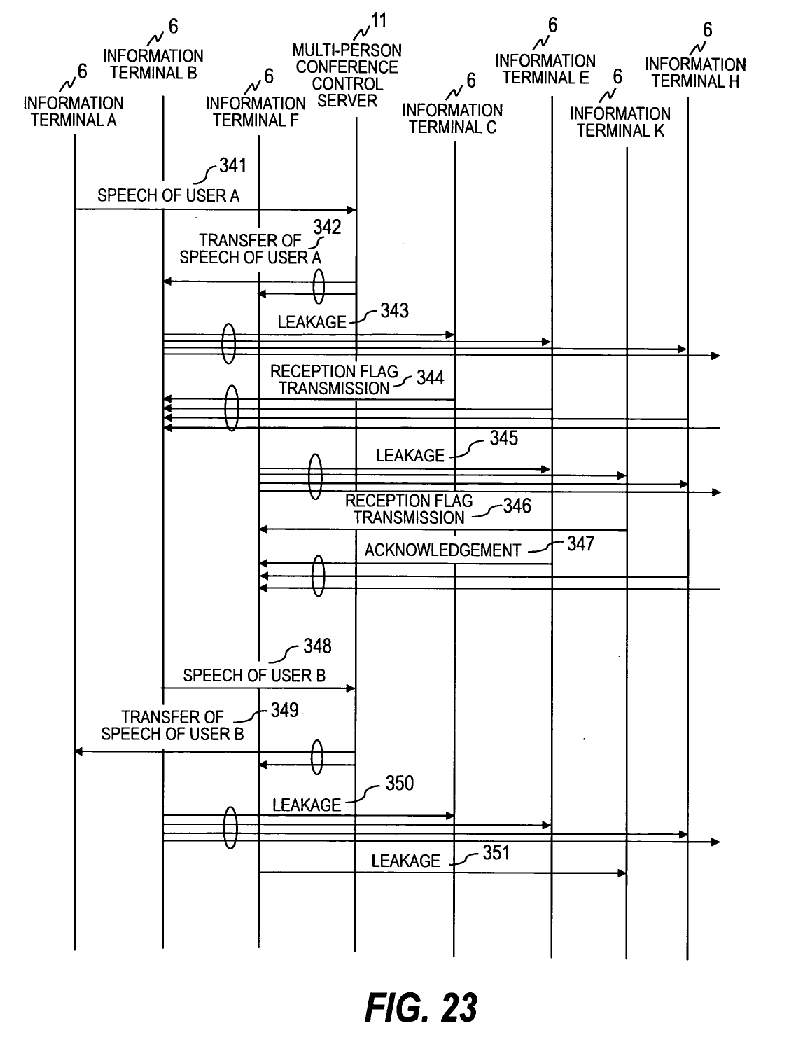

FIG. 23 is a sequential diagram of a process regarding an electronic conference of the communication system according to the seventh embodiment of this invention.

The sequential diagram illustrates a process where users have human relations to each other as shown in FIG. 21. In the sequential diagram, it is presumed that users A, B and F have participated in an electronic conference.

In this case, it is presumed that an information terminal A6 has transmitted a speech of the user A to a multi-person conference control server 11 (341).

The multi-person conference control server 11 receives the speech of the user A. The multi-person conference control server 11 specifies users participating in an electronic conference corresponding to the received speech based on a conference participating user management table 211. Specifically, the multi-person conference control server 11 selects, from the conference participating user management table 211, all records where an identifier of the electronic conference corresponding to the received speech matches a conference ID 212 of the conference participating user management table 211. The multi-person conference control server 11 extracts participating user ID's 213 from all the selected records.

The multi-person conference control server 11 specifies users identified by the extracted participating user ID's 213 as users participating in the electronic conference corresponding to the received speech. In this case, the multi-person conference control server 11 specifies users A, B and F. The multi-person conference control server 11 specifies users other than the user who has made the speech among the specified users. As the user A has made the speech, the multi-person conference control server 11 specifies the users B and F.

The multi-person conference control server 11 transfers the received speech of the user A to information terminals B6 and F6 operated by the specified users B and F, respectively (342).

Each of the information terminals B6 and F6 receives the speech of the user A to display it. Each of the information terminals B6 and F6 carries out a leakage process.

Specifically, the information terminal B6 specifies users present within a predetermined distance from the user B who operates the information terminal B6 based on the route information table 97.

A case where the predetermined distance is “2” will be described. In this case, the information terminal B6 specifies users A, C, E, F and H as users present within the predetermined distance from the user B.

The information terminal B6 specifies users not participating in the electronic conference among the specified users. As the users A and F participate in the electronic conference, the information terminal B6 specifies the users C, E and H. The information terminal B6 distributes a speech of the user A and an identifier of the electronic conference where the speech has been made to all the information terminals 6 operated by the specified users. In this case, the information terminal B6 transmits the speech of the user A and the identifier of the electronic conference where the speech has been made to the information terminals C6, E6, and H6 operated by the users C, E and H, respectively (343).

Each of the information terminals C6, E6 and H6 receives the speech of the user A and the identifier of the electronic conference. Each of the information terminals C6, E6 and H6 judges whether the conversation of the electronic conference identified by the received identifier of the electronic conference has been received.

If the conversation of the electronic conference has been received, the information terminal 6 transmits an acknowledgement to the information terminal 6 which is a distribution source of the speech.

On the other hand, if the conversation of the electronic conference has not been received, the information terminal 6 displays the received speech. The information terminal 6 transmits a reception flag to the information terminal 6 which is a distribution source of the speech.

In this case, each of the information terminals C6, E6 and H6 displays the received speech. Each of the information terminals C6, E6 and H6 transmits the reception flag to the information terminal B6 which is a distribution source of the speech (344).

The information terminal B6 receives the reception flag from each of the information terminals C6, E6 and H6. The information terminal B6 sets a user who operates the information terminal 6 which is a transmission source of the reception flag as a leakage destination user. In this case, the information terminal B6 sets the users C, E and H as leakage destination users. Then, the information terminal B6 distributes the speech of the electronic conference to the information terminals C6, E6 and H6.

The information terminal F6 carries out a leakage process as in the case of the information terminal B6 because the information terminal F6 has received the speech of the user A.

Specifically, the information terminal F6 specifies users present within a predetermined distance from the user F who operates the information terminal F6 based on the route information table 97.

In this case, the information terminal F6 specifies users A, B, E, G, H, I, K and L as users present within the predetermined distance from the user F. The information terminal B6 specifies users not participating in the electronic conference among the specified users. As the users A and B participate in the electronic conference, the information terminal F6 specifies the users E, G, H, I, K and L. The information terminal F6 distributes the speech of the user A and the identifier of the electronic conference where the speech has been made to all the information terminals 6 operated by the specified users. In this case, the information terminal F6 distributes the speech of the user A and the identifier of the electronic conference where the speech has been made to the information terminals E6, G6, H6, I6, K6, and L6 operated by the users E, G, H, I, K and L, respectively (345). In the sequential diagram, processes regarding the information terminals G6, I6, and L6 are omitted.

Each of the information terminals E6, K6 and H6 receives the speech of the user A and the identifier of the electronic conference. Each of the information terminals E6, K6 and H6 judges whether the conversation of the electronic conference identified by the received identifier of the electronic conference has been received.

If the conversation of the electronic conference has been received, the information terminal 6 transmits the acknowledgement to the information terminal 6 which is a distribution source of the speech.

On the other hand, if the conversation of the electronic conference has not been received, the information terminal 6 displays the received speech. The information terminal 6 transmits the reception flag to the information terminal 6 which is a distribution source of the speech.

In this case, the information terminal K6 displays the received speech. The information terminal K6 transmits the reception flag to the information terminal F6 which is a distribution source of the speech (346).

The information terminal F6 receives the reception flag from the information terminal K6. The information terminal F6 sets a user who operates the information terminal 6 which is a transmission source of the reception flag as a leakage destination user. In this case, the information terminal F6 sets the user K as leakage destination user. Then, the information terminal F6 distributes the speech of the electronic conference to the information terminal K6.

On the other hand, each of the information terminals E6 and H6 transmits, because it has received the conversation of the conference, the acknowledgement to the information terminal F6 which is a distribution source of the speech (347).

The information terminal F6 receives the acknowledgement from each of the information terminals E6 and H6. The information terminal F6 does not update leakage destination users. In other words, the information terminal F6 does not set a user who operates the information terminal 6 which is a transmission source of the acknowledgement as a leakage destination user. In this case, the information terminal F6 sets neither of the users E and H as leakage destination users. Accordingly, the information terminal F6 does not distribute the speech of the electronic conference to the information terminals E6 and H6 afterward.

The information terminal A6 distributes the conversation of the electronic conference to none of the information terminals 6, because it is only the users B and F that have direct relations to the user A. Although the information terminal A6 does not distribute the conversation of the electronic conference, one of the information terminals B6 or F6 distributes the conversation of the electronic conference.

Then, it is presumed that the information terminal B6 has transmitted a speech of the user B to the multi-person conference control server 11 (348).

The multi-person conference control server 11 receives the speech of the user B. The multi-person conference control server 11 transfers the speech of the user B to the information terminals A6 and F6 (349).

On the other hand, the information terminal B6 specifies a leakage destination user after it has transmitted the speech of the user B. In this case, the information terminal B6 specifies the users C, E and H as leakage destination users.

The information terminal B6 distributes the speech of the user B to the information terminals 6 operated by the specified users. In this case, the information terminal B6 distributes the speech of the user B to the information terminals C6, E6 and H6 operated by the users C, E and H, respectively (350).

On the other hand, the information terminal F6 receives the speech of the user B from the multi-person conference control server 11. The information terminal F6 displays the received speech. The information terminal F6 specifies a leakage destination user. In this case, the information terminal F6 specifies the user K as a leakage destination user.

The information terminal F6 distributes the received speech of the user B to the information terminal 6 operated by the specified user. In this case, the information terminal F6 distributes the speech of the user B to the information terminal K6 operated by the user K (351).

Then, the electronic conference is similarly continued.

Thus, according to the seventh embodiment, the information terminal 6 can generate conversation leakage.

### Eighth Embodiment

According to the seventh embodiment, the information terminal 6 generates conversation leakage. According to an eighth embodiment, however, the information terminal 6 generates only first conversation leakage. A multi-person conference control server 11 generates second conversation leakage and subsequent conversation leakages subsequent thereto.

A configuration of a communication system of the eighth embodiment is similar to that of the communication system of the seventh embodiment shown in FIG. 4. Components similar to those of the seventh embodiment are denoted by similar reference numerals, and description thereof will be omitted.

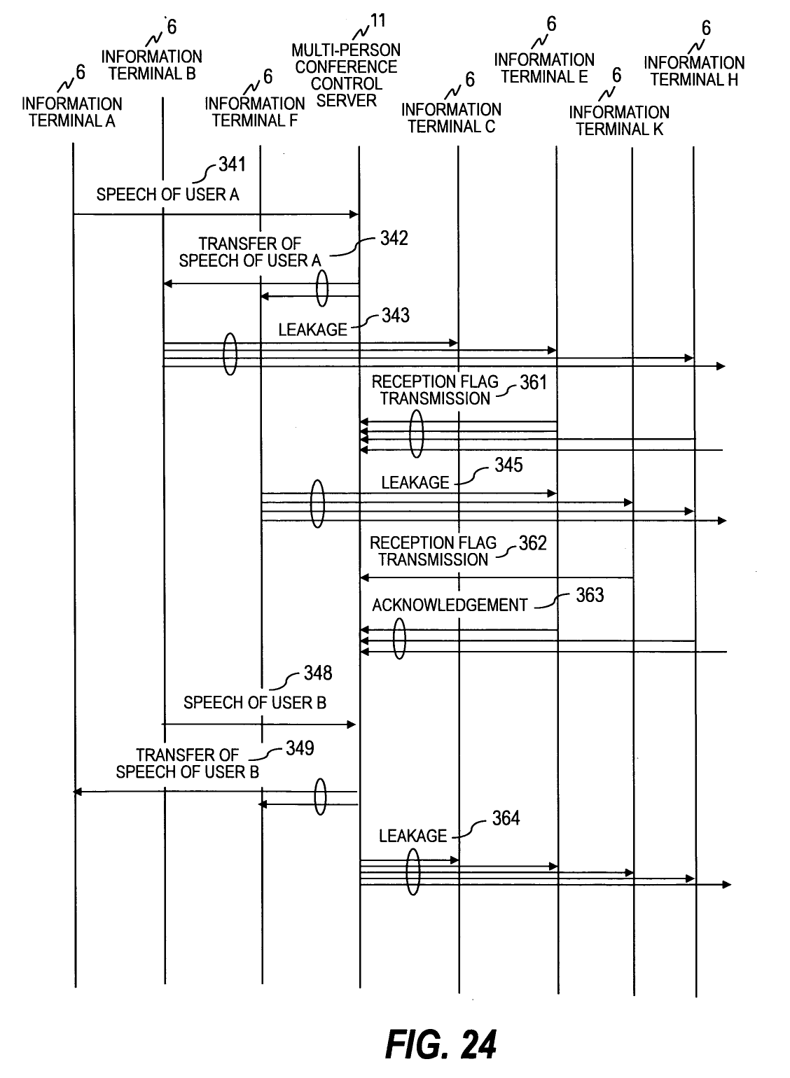

FIG. 24 is a sequential diagram of a process regarding an electronic conference of the communication system according to the eighth embodiment of this invention.

The sequential diagram illustrates a process where users have human relations to each other as shown in FIG. 21. In the sequential diagram, it is presumed that users A, B and F have participated in an electronic conference.

In this case, it is presumed that an information terminal A6 has transmitted a speech of the user A to a multi-person conference control server 11 (341).

The multi-person conference control server 11 receives a speech of the user A. The multi-person conference control server 11 transfers the speech of the user A to information terminals B6 and F6 (342).

Each of the information terminals B6 and F6 receives the speech of the user A to display it. Each of the information terminals B6 and F6 carries out a leakage process.

In this case, the information terminal B6 distributes the speech of the user A to information terminals C6, E6 and H6 (343).

Each of the information terminals C6, E6 and H6 receives the speech of the user A and the identifier of the electronic conference. Each of the information terminals C6, E6 and H6 judges whether the conversation of the electronic conference identified by the received identifier of the electronic conference has been received.

If the conversation of the electronic conference has been received, the information terminal 6 transmits the acknowledgement to the multi-person conference control server 11.

On the other hand, if the conversation of the electronic conference has not been received, the information terminal 6 displays the received speech. The information terminal 6 transmits a reception flag to the multi-person conference control server 11.

In this case, each of the information terminals C6, E6 and H6 displays the received speech. Each of the information terminals C6, E6 and H6 transmits the reception flag to the multi-person conference control server 11 (361).

The multi-person conference control server 11 receives the reception flag from each of the information terminals C6, E6 and H6. The multi-person conference control server 11 sets a user who operates the information terminal 6 which is a transmission source of the reception flag as a leakage destination user. In this case, the multi-person conference control server 11 sets the users C, E and H as leakage destination users. Then, the multi-person conference control server 11 distributes the speech of the electronic conference to the information terminals C6, E6 and H6.

The information terminal F6 carries out a leakage process as in the case of the information terminal B6 because the information terminal F6 has received the speech of the user A.

In this case, the information terminal F6 distributes the speech of the user A to the information terminals E6, G6, H6, I6, K6 and L6 (345). In the sequential diagram, processes regarding the information terminals G6, I6 and L6 are omitted.

Each of the information terminals E6, K6 and H6 receives the speech of the user A and the identifier of the electronic conference. Each of the information terminals E6, K6 and H6 judges whether the conversation of the electronic conference identified by the received identifier of the electronic conference has been received.

If the conversation of the electronic conference has been received, the information terminal 6 transmits the acknowledgement to the multi-person conference control server 11.

On the other hand, if the conversation of the electronic conference has not been received, the information terminal 6 displays the received speech. The information terminal 6 transmits a reception flag to multi-person conference control server 11.

In this case, the information terminal K6 displays the received speech. The information terminal K6 transmits the reception flag to the multi-person conference control server 11 (362).

The multi-person conference control server 11 receives the reception flag from the information terminal K6. The multi-person conference control server 11 sets a user who operates the information terminal 6 which is a transmission source of the reception flag as a leakage destination user. In this case, the multi-person conference control server 11 sets the user K as leakage destination user K. Then, the multi-person conference control server 11 distributes the speech of the electronic conference to the information terminal K6.

Each of the information terminals E6 and H6 transmits, because it has received the conversation of the conference, the acknowledgment to the multi-person conference control server 11 (363).

The multi-person conference control server 11 receives the acknowledgment from each of the information terminals E6 and H6. The multi-person conference control server 11 does not update a leakage destination user.

Then, it is presumed that the information terminal B6 has transmitted a speech of the user B to the multi-person conference control server 11 (348).

The multi-person conference control server 11 receives the speech of the user B. The multi-person conference control server 11 transfers the speech of the user B to the information terminals A6 and F6 (349).

The multi-person conference control server 11 specifies a leakage destination user. In this case, the multi-person conference control server 11 specifies the users C, E, K and H as leakage destination users.

The multi-person conference control server 11 distributes the speech of the user B to the information terminals 6 operated by the specified users. In this case, the multi-person conference control server 11 distributes the speech of the user B to the information terminals C6, E6, K6 and H6 operated by the users C, E, K and H, respectively (364).

Then, the electronic conference is similarly continued.

Thus, according to the eighth embodiment, the information terminal 6 can generate only first conversation leakage. The multi-person conference control server 11 can generate second conversation leakage and conversation leakages subsequent thereto. As a result, loads due to the conversation leakage process of the information terminal 6 can be reduced.

### Ninth Embodiment

According to the seventh embodiment, the information terminal 6 operated by the user participating in the conference generates conversation leakage. According to a ninth embodiment, however, a conversation of an electronic conference is distributed as leakage information hop by hop.

A configuration of a communication system of the ninth embodiment is similar to that of the communication system of the seventh embodiment shown in FIG. 4 except for the fact that an information terminal 6 does not store any route information table 97. Components similar to those of the seventh embodiment are denoted by similar reference numerals, and description thereof will be omitted.

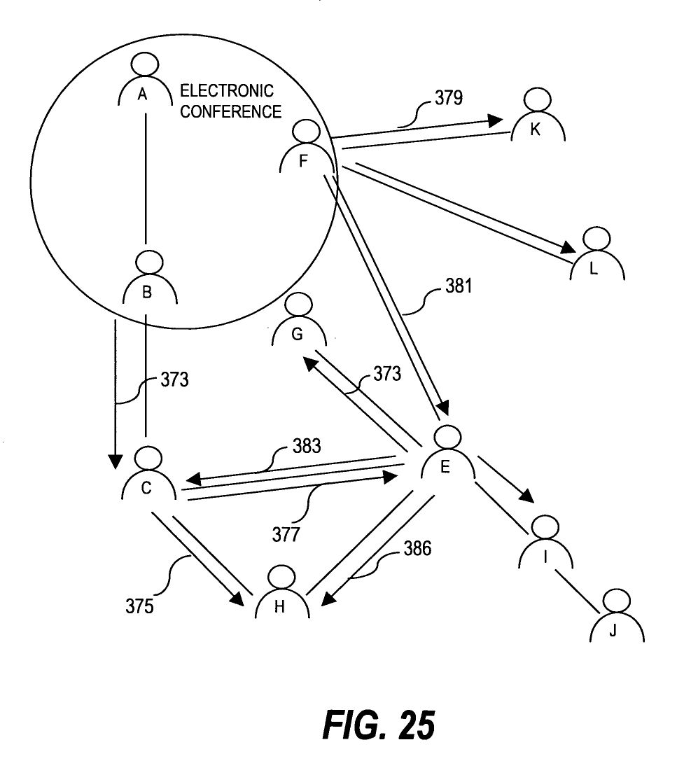

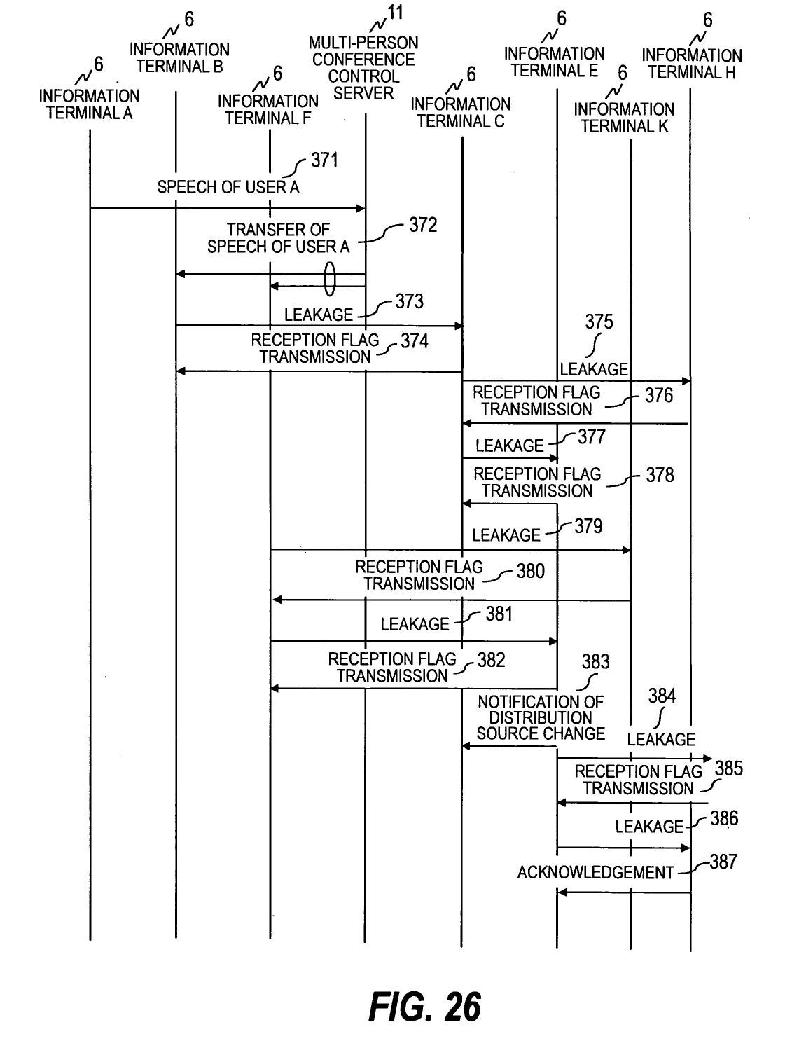

FIG. 25 illustrates a process of the communication system according to the ninth embodiment of this invention. FIG. 26 is a sequential diagram of a process of the communication system according to the ninth embodiment of this invention.

The sequential diagram illustrates a process where users have human relations to each other as shown in FIG. 25. In the sequential diagram, it is presumed that users A, B and F have participated in an electronic conference.

In this case, it is presumed that an information terminal A6 has transmitted a speech of the user A to a multi-person conference control server 11 (371).

The multi-person conference control server 11 receives the speech of the user A. The multi-person conference control server 11 specifies users participating in an electronic conference corresponding to the received speech based on a conference participating user management table 211. Specifically, the multi-person conference control server 11 selects, from the conference participating user management table 211, all records where an identifier of the electronic conference corresponding to the received speech matches a conference ID 212 of the conference participating user management table 211. The multi-person conference control server 11 extracts participating user ID's 213 from all the selected records.

The multi-person conference control server 11 specifies users identified by the extracted participating user ID's 213 as users participating in the electronic conference corresponding to the received speech. In this case, the multi-person conference control server 11 specifies users A, B and F. The multi-person conference control server 11 specifies users other than the user which has made the speech among the specified users. As the user A has made the speech, the multi-person conference control server 11 specifies the users B and F.

The multi-person conference control server 11 transfers the speech of the user A to information terminals B6 and F6 operated by the specified users B and F, respectively (372).

Each of the information terminals B6 and F6 receives the speech of the user A to display it. Each of the information terminals B6 and F6 carries out a leakage process.

Specifically, the information terminal B6 specifies users having direct relations to the user B who operates the information terminal B6 based on a private relation information table 89. In other words, the information terminal B6 specifies users having human relations to the user B who operates the information terminal B6.

In this case, the information terminal B6 specifies the user C as a user having a direct relation to the user B.

The information terminal B6 specifies users not participating in the electronic conference among the specified users. As the users A and F participate in the electronic conference, the information terminal B6 specifies the user C. The information terminal B6 distributes the speech of the user A, an identifier of the electronic conference where the speech has been made, and distance information to the information terminal 6 operated by the specified user. In this case, the information terminal B6 distributes the speech of the user A, the identifier of the electronic conference where the speech has been made, and distance information to the information terminal C6 operated by the user C (373). The distance information indicates a distance between a user participating in the electronic conference and a user who operates an information terminal 6 which is a distribution destination. In this case, the distance information is “1” which is a distance between the users B and C.

The information terminal C6 receives the speech of the user A, the identifier of the electronic conference, and the distance information. The information terminal C6 judges whether the conversation of the electronic conference identified by the received identifier of the electronic conference has been received.

If the conversation of the electronic conference has been received, the information terminal 6 selects, among all the received pieces of distance information, distance information indicating a smallest value. The information terminal 6 transmits a reception flag to the information terminal 6 which is a transmission source of the selected distance information. The information terminal 6 transmits a notification of a reception source change to the information terminal 6 which is a transmission source of the unselected distance information. Accordingly, the information terminal 6 can receive the conversation of the electronic conference through a route of a shortest distance.

On the other hand, if the conversation of the electronic conference has not been received, the information terminal 6 displays the received speech. The information terminal 6 transmits a reception flag to the information terminal 6 which is a distribution source of the speech.

In this case, the information terminal C6 displays the received speech. The information terminal C6 transmits the reception flag to the information terminal B6 which is a distribution source of the speech (374).

The information terminal B6 receives the reception flag from the information terminal C6. The information terminal B6 sets a user who operates the information terminal 6 which is a transmission source of the reception flag as a leakage destination user. In this case, the information terminal B6 sets the user C as a leakage destination user. Then, the information terminal B6 distributes the speech of the electronic conference to the information terminal C6.

Upon reception of the reception flag, the information terminal C6 judges whether the received distance information is less than a predetermined value.

If the distance information is equal to or more than the predetermined value, the information terminal C6 does not distribute the received speech of the user A to the other information terminals 6.

On the other hand, if the distance information is less than the predetermined value, the information terminal C6 distributes the received speech of the user A to the other information terminals 6.

The embodiment will be described by way of case where a predetermined value is “2”.

In this case, as distance information is less than the predetermined value, the information terminal C6 distributes the received speech of the user A to the other information terminals 6.

Specifically, the information terminal C6 specifies users having direct relations to the user C who operates the information terminal C6 based on the private relation information table 89. In other words, the information terminal C6 specifies the users E and H as users having direct relations to the user C.

The information terminal C6 specifies users not participating in the electronic conference among the specified users. As the users A, B and F participate in the electronic conference, the information terminal C6 specifies the users E and H. The information terminal C6 distributes the speech of the user A, an identifier of the electronic conference, and distance information to the information terminals 6 operated by the specified users. In this case, the information terminal C6 distributes the speech of the user A, the identifier of the electronic conference, and the distance information to the information terminals E6 and H6 operated by the users E and H, respectively (375, and 377). The distance information indicates “2” which is a distance between the users B and R or H.

Each of the information terminals E6 and H6 receives the speech of the user A, the identifier of the electronic conference, and the distance information. Each of the information terminals E6 and H6 judges whether the conversation of the electronic conference identified by the received identifier of the electronic conference has been received.

If the conversation of the electronic conference has been received, the information terminal 6 selects, among all the received pieces of distance information, distance information indicating a smallest value. The information terminal 6 transmits a reception flag to the information terminal 6 which is a transmission source of the selected distance information. The information terminal 6 transmits a notification of a reception source change to the information terminal 6 which is a transmission source of the unselected distance information.

On the other hand, if the conversation of the electronic conference has not been received, the information terminal 6 displays the received speech. The information terminal 6 transmits a reception flag to the information terminal 6 which is a distribution source of the speech.

In this case, each of the information terminal E6 and H6 displays the received speech. Each of the information terminals E6 and H6 transmits the reception flag to the information terminal C6 which is a distribution source of the speech (376, 378).

The information terminal C6 receives the reception flag from the information terminals E6 and H6. The information terminal C6 sets a user who operates the information terminal 6 which is a transmission source of the reception flag as a leakage destination user. In this case, the information terminal C6 sets the users E and H as leakage destination users. Then, the information terminal C6 distributes the speech of the electronic conference to the information terminals E6 and H6.

Upon reception of the reception flag, each of the information terminals E6 and H6 judges whether the received distance information is less than a predetermined value.

If the distance information is equal to or more than the predetermined value, each of the information terminals E6 and H6 does not distribute the received speech of the user A to the other information terminals 6.

On the other hand, if the distance information is less than the predetermined value, each of the information terminals E6 and H6 distributes the received speech of the user A to the other information terminals 6.

In this case, as the distance information is equal to or more than the predetermined value, neither of the information terminals E6 and H6 distributes the received speech of the user A to the other information terminals 6.

The information terminal F6 receives the speech of the user A to display the received speech in the step 372. The information terminal F6 carries out a leakage process.

Specifically, the information terminal F6 specifies users having direct relations to the user F who operates the information terminal F6 based on the private relation information table 89. In other words, the information terminal F6 specifies users having human relations to the user F who operates the information terminal F6.

In this case, the information terminal F6 specifies the users E and K as users having direct relations to the user F.

The information terminal F6 specifies users not participating in the electronic conference among the specified users. As the users A, E and F participate in the electronic conference, the information terminal F6 specifies the users E and K. The information terminal F6 distributes the speech of the user A, an identifier of the electronic conference where the speech has been made, and distance information to the information terminals 6 operated by the specified users. In this case, the information terminal F6 distributes the speech of the user A, the identifier of the electronic conference where the speech has been made, and distance information to the information terminals E6 and K6 operated by the users E and K, respectively (379, and 381). The distance information indicates a distance between a user participating in the electronic conference and a user who operates an information terminal 6 which is a distribution destination. In this case, the distance information indicates 1” which is a distance between the users F and E or K.

The information terminal K6 receives the speech of the user A, the identifier of the electronic conference, and the distance information. The information terminal K6 judges whether the conversation of the electronic conference identified by the received identifier of the electronic conference has already been received.

If the conversation of the electronic conference has already been received, the information terminal 6 selects, among all the received pieces of distance information, distance information indicating the smallest value. The information terminal 6 transmits a reception flag to the information terminal 6 which is a transmission source of the selected distance information. The information terminal 6 transmits a notification of a reception source change to the information terminal 6 which is a transmission source of the unselected distance information.

On the other hand, if the conversation of the electronic conference has not been received, the information terminal 6 displays the received speech. The information terminal 6 transmits a reception flag to the information terminal 6 which is a distribution source of the speech.

In this case, the information terminal K6 displays the received speech. The information terminal K6 transmits the reception flag to the information terminal F6 which is a distribution source of the speech (380).

The information terminal F6 receives the reception flag from the information terminal K6. The information terminal F6 sets a user who operates the information terminal 6 which is a transmission source of the reception flag as a leakage destination user. In this case, the information terminal F6 sets the user K as a leakage destination user. Then, the information terminal F6 distributes the speech of the electronic conference to the information terminal K6.

The information terminal E6 receives the speech of the user A, the identifier of the electronic conference, and the distance information from the information terminal F6. The information terminal E6 judges whether the conversation of the electronic conference identified by the received identifier of the electronic conference has already been received.

If the conversation of the electronic conference has already been received, the information terminal 6 selects, among all the received pieces of distance information, distance information indicating the smallest value. The information terminal 6 transmits a reception flag to the information terminal 6 which is a transmission source of the selected distance information. The information terminal 6 transmits a notification of a distribution source change to the information terminal 6 which is a transmission source of the unselected distance information. Accordingly, the information terminal 6 can receive the conversation of the electronic conference through a route of the shortest distance.

On the other hand, if the conversation of the electronic conference has not been received, the information terminal 6 displays the received speech. The information terminal 6 transmits a reception flag to the information terminal 6 which is a distribution source of the speech.

In this case, the information terminal E6 transmits the reception flag to the information terminal F6 which is a transmission source of the distance information indicating “1” (382). The information terminal E6 transmits the notification of a distribution source change to the information terminal C6 which is a transmission source of the distance information indicating “2”.

The information terminal F6 receives the reception flag from the information terminal E6. The information terminal F6 sets a user who operates the information terminal 6 which is a transmission source of the reception flag as a leakage destination user. In this case, the information terminal F6 sets the user E as a leakage destination user. Then, the information terminal F6 distributes the speech of the electronic conference to the information terminal E6.

The information terminal C6 receives the notification of a distribution source change from the information terminal E6. The information terminal C6 excludes the user who operates the information terminal 6 which is a transmission source of the notification of the distribution source change from leakage destination users. In this case, the information terminal C6 excludes the user E from the leakage destination users. The information terminal C6 distributes the speech of electronic conference no more to the information terminal E6.

Upon transmission of the reception flag and the notification of a distribution source change, the information terminal E6 judges whether the received distance information is less than a predetermined value.

If the distance information is equal to or more than the predetermined value, the information terminal E6 does not distribute the received speech of the user A to the other information terminals 6.

On the other hand, if the distance information is less than the predetermined value, the information terminal E6 distributes the received speech of the user A to the other information terminals 6.

In this case, as the distance value is less than the predetermined value, the information terminal E6 distributes the received speech of the user A to the other information terminals 6.

Specifically, the information terminal E6 specifies users having direct relations to the user E who operates the information terminal E6 based on the private relation information table 89. In this case, the information terminal E6 specifies the users K and H as users having direct relations to the user E.

The information terminal E6 specifies users not participating in the electronic conference among the specified users. As the users A, B and F participate in the electronic conference, the information terminal E6 specifies the users I and H. The information terminal E6 distributes the speech of the user A, an identifier of the electronic conference, and distance information to the information terminals 6 operated by the specified users. In this case, the information terminal E6 distributes the speech of the user A, the identifier of the electronic conference, and distance information to the information terminals 16 and H6 respectively operated by the users I and H (384 and 386). The distance information indicates “2” which is a distance between the users F and I or H.

Each of the information terminals 16 and H6 receives the speech of the user A, the identifier of the electronic conference, and the distance information. Each of the information terminals 16 and H6 judges whether the conversation of the electronic conference identified by the received identifier of the electronic conference has already been received.

If the conversation of the electronic conference has already been received, the information terminal 6 selects, among all the received pieces of distance information, distance information indicating the smallest value. The information terminal 6 transmits a reception flag to the information terminal 6 which is a transmission source of the selected distance information. The information terminal 6 transmits a notification of a reception source change to the information terminal 6 which is a transmission source of the unselected distance information. When a plurality of pieces of distance information indicating the smallest value are received, the information terminal 6 transmits an acknowledgement to information terminals 6 which are transmission sources of, among the plurality of pieces of distance information indicating the smallest value, pieces of distance information other than the first received distance information.

On the other hand, if the conversation of the electronic conference has not been received, the information terminal 6 displays the received speech. The information terminal 6 transmits a reception flag to the information terminal 6 which is a distribution source of the speech.

In this case, the information terminal 16 displays the received speech. The information terminal 16 transmits the reception flag to the information terminal E6 which is a distribution source of the speech (385).

The information terminal E6 receives the reception flag from the information terminal 16. The information terminal E6 sets a user who operates the information terminal 6 which is a transmission source of the reception flag as a leakage destination user. In this case, the information terminal E6 sets the user I as a leakage destination user. Then, the information terminal E6 distributes the speech of the electronic conference to the information terminal 16.

The information terminal H6 transmits the acknowledgement to the information terminal E6 which is a distribution source of the speech (387).

The information terminal E6 receives the acknowledgement from the information terminal H6. The information terminal E6 does not update the leakage destination user. In other words, the information terminal E6 does not set a user who operates the information terminal E6 which is a transmission source of the acknowledgement as a leakage destination user. In this case, the information terminal E6 does not set the user H as a leakage destination user. Accordingly, the information terminal E6 distributes the conversation of the electronic conference no more to the information terminal H6.

Upon transmission of the reception flag or the acknowledgement, each of the information terminals 16 and H6 judges whether the received distance information is less than a predetermined value.

If the distance information is equal to or more than the predetermined value, neither of the information terminals 16 and H6 distributes the received speech of the user A to the other information terminals 6.

On the other hand, if the distance information is less than the predetermined value, each of the information terminals 16 and H6 distributes the received speech of the user A to the other information terminals 6.

Because the distance information is equal to or more than the predetermined value, neither of the information terminals 16 and H6 distributes the received speech of the user A to the other information terminals 6.

Then, the electronic conversation is similarly continued.

Thus, according to the ninth embodiment, the conversation of the electronic conference can be distributed as leakage information hop by hop. According to the ninth embodiment, as no route information needs to be updated, loads on the network and the information terminal 6 can be reduced.

### Tenth Embodiment

According to the first to ninth embodiments, the conversation of the electronic conference is leaked. According to a tenth embodiment, however, contents of a blog are leaked. The tenth embodiment can be applied to any one of the first to ninth embodiments.

A communication system of the tenth embodiment includes a blog server 13 in place of the multi-person conference control server 11. Other components of a computer system of the tenth embodiment are similar to those of the communication system of the first embodiment shown in FIG. 4. Components similar to those of the first embodiment are denoted by similar reference numerals, and description thereof will be omitted. The blog server 13 is a computer for providing blog services to information terminals 6.

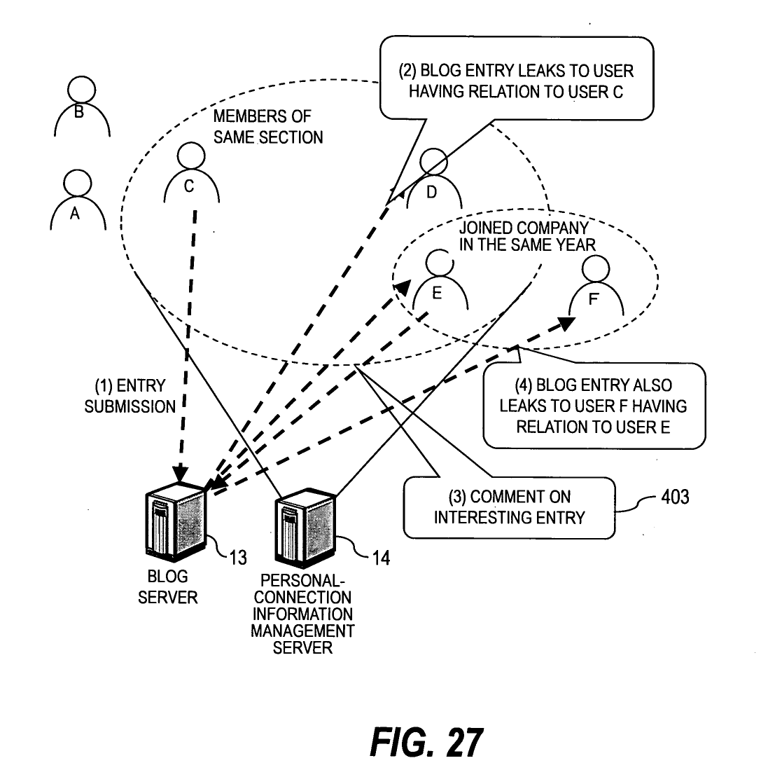

FIG. 27 illustrates an operation concept of the communication system according to the tenth embodiment of this invention.

In blog services, each user posts his own diary as an entry of a blog. A user who reads the posted entry posts a comment. Through mutual notification of a deep relation between entries made by different users (track back function), the users can deepen discussion with each other.

According to the embodiment, not user's speech but a blog entry becomes leakage information.

A case where a user C posts an entry will be described. An information terminal C6 operated by the user C transmits an entry posting request to the blog server 13. If a user who has posted an entry and a user who has posted a comment on the entry belong to the same group, the entry posting request can be considered as a group creation request.

The blog server 13 receives the entry posting request. The blog server 13 carries out the same process as that of the multi-person conference control server 11.

Specifically, the blog server 13 specifies users D and E having human relations to the user C, and leaks contents of an entry to the specified users D and E. In other words, the blog server 13 distributes contents of the entry posted by the user C to information terminals D6 and E6 respectively operated by the specified users D and E.

Then, it is presumed that the user E has posted a comment on the entry. In this case, the information terminal E6 operated by the user E transmits a comment posting request to the blog server 13. If a user who has posted an entry and a user who has posted a comment on the entry belong to the same group, the comment posting request can be considered as a group creation request.

The blog server 13 receives a comment posting request. The blog server 13 carries out the same process as that of the multi-person conference control server 11. Accordingly, the blog server 13 treats the users C and E as in the case of a status where the users participate in one electronic conference.

Specifically, the blog server 13 specifies the user F who has a human relation to the user E, and leaks contents of an entry to the specified user F. In other words, the blog server 13 distributes contents of the entry posted by the user C to the information terminal F6 operated by the specified user F.

Thus, according to the tenth embodiment, contents of a blog entry can be leaked to a user having a human relation to a user who has posted the entry and a user who has posted a comment on the entry. As a result, the user can know the blog entry by a method other than search.

### Eleventh Embodiment

According to the sixth embodiment, the route information is automatically generated or updated. According to an eleventh embodiment, Know-Who services using the generated or updated route information are provided.

A communication system of the eleventh embodiment includes a Know-Who server 12 in place of the multi-person conference control server 11. Other components of a computer system of the eleventh embodiment are similar to those of the communication system of the first embodiment shown in FIG. 4. Components similar to those of the first embodiment are denoted by similar reference numerals, and description thereof will be omitted. The Know-Who sever 12 is a computer for providing Know-Who services to information terminals 6.

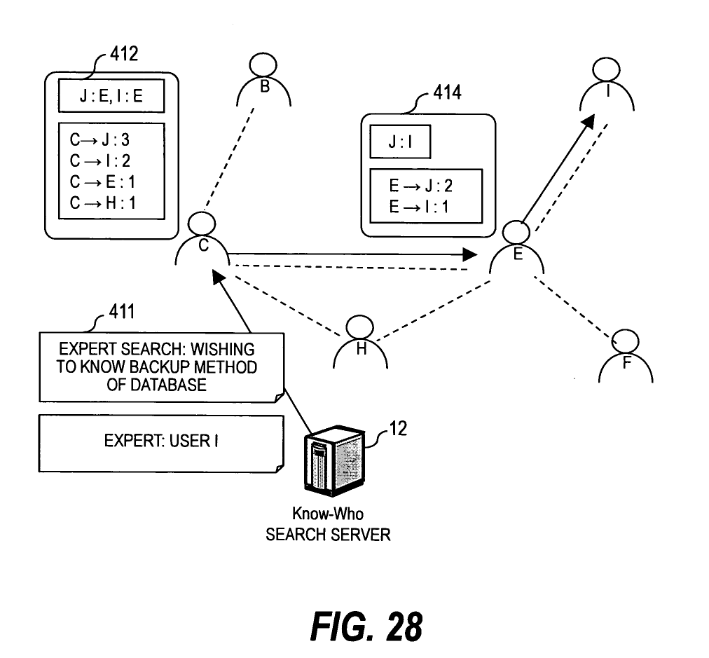

FIG. 28 illustrates an operation concept of the communication system according to the eleventh embodiment of this invention.

In Know-Who services, a user search for a user (expert) knowledgeable about information to be wished to obtain. The user obtains information by asking the searched expert to provide information. In this case, if the user has an introduction from one of expert's acquaintances, user's psychological resistance to abrupt requesting of information provision to the unacquainted expert can be reduced.

In the same process as that of the sixth embodiment, it is presumed that all the information terminals 6 have updated or generated route information. An information terminal C6 operated by the user C transmits an expert search request to the Know-Who server 12 (411). The Know-Who server 12 receives the expert search request to search an expert. Then, the Know-Who server 12 transmits a result of the search to the information terminal C6. Accordingly, the user C understands that a user I is an expert.

The user C refers to route information 412 stored in the information terminal C6 to understand that a user E is first passed so as to reach the user I. The user C asks the user E to serve as an intermediary for an information providing request to the user I. In this case, as the user C has a human relation to the user E, asking the user E to serve as the intermediary imposes no psychological resistance on the user C.

The user E asked to serve as the intermediary refers to route information 414 stored in an information terminal E6 to understand that the user E has a direct relation to the user I. The user E asks the user I to provide information to the user C. In this case, as the user E has a human relation to the user I, asking the user I to provide information imposes no psychological resistance on the user E.

Thus, the user C can receive information from the user I to whom the user C has no direct relation.

As described above, according to the eleventh embodiment, without any leakage of a private human relation around, the user can receive information from an expert.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising:
a plurality of first computers operated by users; and
a second computer coupled to the plurality of first computers via a network,
wherein the second computer is configured to:
receive a group creation request from one of the plurality of first computers;
create a group to which one or more of the users belong based on the received group creation request;
specify, among users having relation to a user who operates the one of the plurality of first computers that transmitted the received group creation request, users not belonging to the created group as leakage destination users; and
transmit information received from one of the plurality of first computers operated by one of the users belonging to the created group to first computers operated by the specified leakage destination users.

2. The computer system according to claim 1, wherein:
users participating in an electronic conference belong to the group;
the group creation request includes a request for participation in the electronic conference; and
the information that the second computer has received from the one of the plurality of first computers includes a speech made at the electronic conference.

3. The computer system according to claim 1, wherein:
a user who has written an entry in a blog and a user who has written a comment on the entry of the blog belong to the same group;
the group creation request includes one of a request for writing an entry in the blog and a request for writing a comment on the entry of the blog; and
the information that the second computer has received from the one of the plurality of first computers includes the entry of the blog and the comment on the entry of the blog.

4. The computer system according to claim 1, wherein the second computer is configured to transmit information received from the one of the plurality of first computers operated by the one of the users belonging to the created group to, among first computers operated by the users belonging to the created group, a first computer which is not a transmission source of the received information.

5. The computer system according to claim 1, further comprising a third computer for managing a relation between users, wherein
the second computer is configured to make an inquiry about a user having relation to the user who operates the one of the plurality of first computers that transmit the received group creation request to the third computer.

6. The computer system according to claim 1, wherein the second computer is configured to:
analyze contents of the information received from the one of the plurality of first computers operated by the one of the users belonging to the created group;
select a leakage destination user who wishes to obtain information of the analyzed contents among the specified leakage destination users; and
transmit the information received from the one of the plurality of first computers operated by the one of the users belonging to the created group to a first computer operated by the selected leakage destination user.

7. The computer system according to claim 1, wherein the second computer is configured to:
obtain status of the specified leakage destination users; and
judge, based on the obtained status of the leakage destination users, whether to transmit the information received from the one of the plurality of first computers operated by the one of the users belonging to the created group to first computers operated by the leakage destination users.

8. A computer system comprising:
a plurality of first computers operated by users; and
a second computer coupled to the plurality of first computers via a network,
wherein the second computer is configured to:
receive a group creation request from one of the plurality of first computers;
create a group to which one or more of the users belong based on the received group creation request; and
transmit information received from one of the plurality of first computers operated by one of the users belonging to the created group to, among the first computers operated by the users belonging to the created group, a first computer which is not a transmission source of the received information, and
wherein each of the plurality of first computers operated by one of the users belonging to the created group is configured to:
specify, among users having relations to a user who operates the first computer, users not belonging to the creation group as leakage destination users; and
transmit one of the information transmitted to the second computer and the information received from the second computer to first computers operated by the specified leakage destination users.

9. The computer system according to claim 8, wherein:
users participating in an electronic conference belong to the group;
the group creation request includes a request for participation in the electronic conference; and
the information that the second computer has received from the one of the plurality of first computers includes a speech made at the electronic conference.

10. The computer system according to claim 8, wherein:
a user who has written an entry in a blog and a user who has written a comment on the entry of the blog belong to the same group;
the group creation request includes one of a request for writing an entry in the blog and a request for writing a comment on the entry of the blog; and
the information that the second computer has received from the one of the plurality of first computers includes the entry of the blog and the comment on the entry of the blog.

11. The computer system according to claim 8, wherein each of the plurality of first computers operated by one of the users belonging to the created group is configured to:
analyze contents of one of the information transmitted to the second computer and the information received from the second computer;
select a leakage destination user who wishes to obtain information of the analyzed contents among the specified leakage destination users; and
transmit the one of the information transmitted to the second computer and the information received from the second computer to a first computer operated by the selected leakage destination user.

12. The computer system according to claim 8, wherein each of the first plurality of computers operated by one of the users belonging to the created group is configured to:
obtain statues of the specified leakage destination users; and
judge, based on the obtained status of the leakage destination users, whether to transmit one of the information transmitted to the second computer and the information received from the second computer to the first computers operated by the leakage destination users.

13. The computer system according to claim 8, wherein each of the plurality of first computers is configured to:
store relation information indicating users having relations to a user who operates the first computer;
refer to the relation information to specify, among the users having relations to the user who operates the first computer, users not belonging to the created group as leakage destination users;
update the relation information stored in the first computer based on the received update notification upon reception of an update notification of the relation information from another first computer; and
transmit the update notification of the relation information to first computers operated by the users having relations to the user who operates the first computer.

14. A management computer coupled to a plurality of client computers operated by users via a network, the management computer being configured to:
receive a group creation request from one of the plurality of client computers;
create a group to which one or more of the users belong based on the received group creation request;
specify, among users having relations to a user who operates the one of the plurality of client computers that transmitted the received group creation request, users not belonging to the created group as leakage destination users; and
transmit information received from one of the plurality of client computers operated by one of the users belonging to the created group to client computers operated by the specified leakage destination users.

15. The management computer according to claim 14, wherein:
users participating in an electronic conference belong to the group;
the group creation request includes a request for participation in the electronic conference; and
the information received from the one of the plurality of client computers includes a speech made at the electronic conference.

16. The management computer according to claim 14, wherein:
a user who has written an entry in a blog and a user who has written a comment on the entry of the blog belong to the same group;
the group creation request includes one of a request for writing an entry in the blog or a request for writing a comment on the entry of the blog; and
the information received from the one of the plurality of client computers includes the entry of the blog and the comment on the entry of the blog.

17. The management computer according to claim 14, wherein the management computer is further configured to transmit information received from the one of the plurality of client computers operated by the one of the users belonging to the created group to, among client computers operated by the users belonging to the created group, a client computer which is not a transmission source of the received information.

18. The management computer according to claim 14, wherein the management computer is further configured to:
analyze contents of the information received from the one of the plurality of client computers operated by the one of the users belonging to the created group;
select a leakage destination user who wishes to obtain information of the analyzed contents among the specified leakage destination users; and
transmit the information received from the one of the plurality of client computers operated by the one of the users belonging to the created group to a client computer operated by the selected leakage destination user.

19. The management computer according to claim 14, wherein the management computer is further configured to:
obtain status of the specified leakage destination users; and
judge, based on the obtained status of the leakage destination users, whether to transmit the information received from the one of the plurality of client computers operated by the one of the users belonging to the created group to client computers operated by the leakage destination users.

20. A computer system comprising a plurality of computers operated by users,
wherein each of the plurality of computers is configured to:
store relation information indicating users having relations to a user who operates the computer;
update, upon reception of an update notification of the relation information from another computer, the relation information stored in the computer based on the received update notification; and
transmit the update notification of the relation information to computers operated by the users having relations to the user who operates the computer.
